(19) United States
(12) Patent Application Publication
(10) Pub. No.: US 2014/0139961 A1
(43) Pub. Date: May 22, 2014

(54) DEVICE FOR PROVIDING PROTECTION AGAINST ELECTRICAL SHOCK HAZARDS INVOLVING TWO CIRCUIT CONDUCTORS

(71) Applicants: Tyrone J. Mellon, JR., Bridgeport, CT (US); Ryan Alan Munden, Trumbull, CT (US)

(72) Inventors: Tyrone J. Mellon, JR., Bridgeport, CT (US); Ryan Alan Munden, Trumbull, CT (US)

(21) Appl. No.: 14/085,584

(22) Filed: Nov. 20, 2013

Related U.S. Application Data
(60) Provisional application No. 61/728,988, filed on Nov. 21, 2012.

(51) Int. Cl. H02H 3/00; H02H 3/26

(52) U.S. Cl. CPC H02H 3/00; H02H 3/26
USPC 361/87; 361/78

(57) ABSTRACT

Disclosed herein is a device that protects against electrical shock hazards involving two circuit conductors. The device continuously evaluates the load characteristics of electrical equipment and automatically provides feedback on status and changes of such equipment. The device has a “learning mode” wherein it stores the load characteristics of loads connected to the device. The device also has an “protection mode” (or “normal mode”) wherein the devices compares connected load characteristics to stored load characteristics, and based on this comparison determines if an electrical fault is present. If the device determines that an electrical fault is present, the device then takes action to protect against electrical shock, such as by disconnecting the system from power.

### CROSS REFERENCE TO RELATED APPLICATIONS

This application claims the benefit of U.S. Provisional Patent Application No. 61/728,988 filed march Nov. 21, 2012, the disclosure of which is hereby incorporated by reference in its entirety.

### FIELD OF THE INVENTION

The present invention relates to a learning device that continuously evaluates the load characteristics of electrical equipment and automatically provides feedback on status and changes of such equipment, and further relates to learning devices that provide personal protection against electrical shock hazards based on said learning and evaluation capabilities.

### BACKGROUND OF THE INVENTION

Electrical circuit faults pose a hazard to people working with and around electrical equipment. Personal Protective Equipment (PPE) is frequently deployed to minimize the risk of injury. One type of PPE consists of items a person wears while working with electricity, such as flame retardant clothes and insulated gloves. This clothing type PPE is intended for use by qualified personnel working with electrical equipment and is designed to protect the person wearing the equipment from coming into contact with an energized wire(s), or arcing and blasts. Another type of PPE employed consists of electrical or electronic devices that will rapidly disconnect a circuit if a fault occurs.

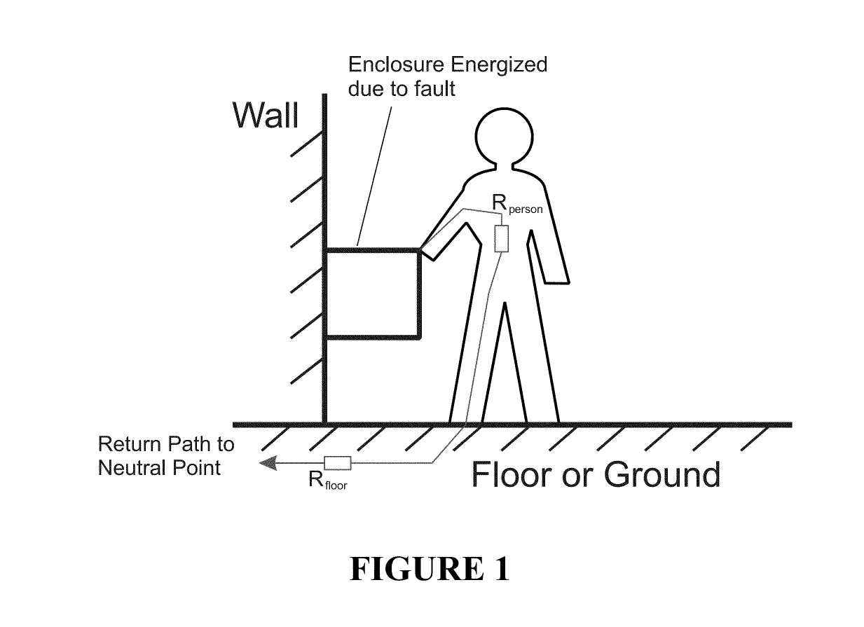

A Ground Fault Protector (GFP) is an example of one such a PPE. The name “ground fault protector” is a bit of a misnomer as GFPs do not require a ground wire to function. A GFP is a device that de-energizes a circuit within an established period of time when the leakage current out of the circuit conductors exceeds some predetermined value that is less than that required to operate the overcurrent protective device of the supply circuit. Leakage current is any current not returning through one of the circuit conductors, but is instead returning to the circuit through a different path, typically the neutral point, through ground (FIG. 1).

Ground fault circuit interrupters (GFCIs) are a specific type of GFP. Underwriters Laboratories Inc, “UL 943,” in Ground Fault Circuit Interrupters, See Underwriters Laboratories Inc, 2006, pp. 6.7.1.1-6.7.1.3. They are frequently deployed to protect people from faults involving a single circuit conductor and ground. A GFCI measures the differential current of all the circuit conductors on a given branch and will disconnect power to the branch if the differential is above a certain value. The assumption is that any current not returning through the circuit conductors, is returning through an unintended path to earth that may or may not include a person or other living being (e.g. pet, livestock). GFCIs and other devices that work on the principle of differential current measurements do not provide protection for a person or other living being against faults involving two circuit conductors as the person would simply appear as a load on the system. Leviton Manufacturing Co., “Installing and Testing a GFCI Receptacle;” http://www.leviton.com/OA_HTML/ibcGetAttachment.jsp?cItemId=vou.klnRdMYBhNwUQoly iw&label=IBE&appName=IBE&minisite=10251 (Accessed Jul. 15, 2012).

When installed on a circuit, GFCIs will disconnect power to the circuit if the differential between the current going into a circuit to that returning through the circuit exceeds 6 mA. GFCIs are commercially available that work on circuits from 15 A to 100 A, in either single phase or 3 phase power systems. GFCIs are deployed as cord connected devices, panelmount devices, and as integral components of an outlet.

Residual Current Devices (RCDs) are used to protect people or other living being and equipment from leakage currents in most countries where the electrical codes do not require GFCIs. Current response thresholds can vary between 10 mA and 30 mA for personal protection, and 500 mA for equipment protection.

Arc Fault Circuit Interrupters (AFCIs) are safety devices designed to detect the presence of certain intermittent or arcing faults in wires or cords. An AFCI will evaluate the current flow and disconnect power to a circuit if the “load” appears to be an arcing fault. AFCIs do not assure personal protection, although they can prevent intermittent circuit faults that may escalate into a fire hazard.

GFCIs and RCDs provide no protection to personnel or other living being when the current path through a person does not go through ground, but instead through two circuit conductors, either two phase conductors or a phase conductor and a neutral conductor. Underwriters Laboratories (UL) acknowledges this electrical shock safety hazard and requires manufacturers to place the following text in their installation instructions for GFCIs: “A GFCI Receptacle does not protect against circuit overloads, short circuits, or shocks. For example, you can still be shocked if you touch bare wires while standing on a non-conducting surface such as a wood floor.” UL 943, supra, at p. SA12.

According to OSHA, there were 170 work place fatalities due to contact with electrical conductors in the United States in 2009. U.S. Bureau of Labor Statistics, “CFTB May 4, 2011 TABLE A-9. Fatal occupational injuries by event or exposure for all fatalities and major private industry sector, All United States, 2009;” http://www.bls.gov/iif/oshwc/cfoi/cftb0249.pdf (Accessed Dec. 9, 2011).

A simple hazard to understand is someone cutting a cord on an appliance while the cord is energized or a person inserting conductive objects into a wiring device. A hidden hazard is the contact of neutral to a person, normally at a potential very close to earth and would not cause any current to flow through a person, and then introduce a loose phase conductor resulting in current flow through the person. Defective equipment or incorrect installation of electrical equipment can also lead to injury.

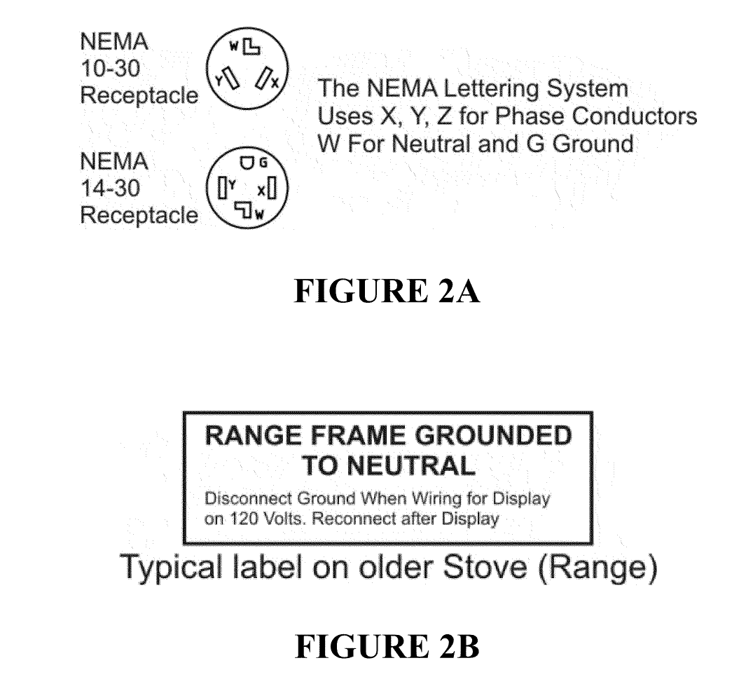

Larger household appliances such as dryers and stoves in houses built before 1996, generally used NEMA 10-30 or 10-50 Outlets to connect to power. National Electrical Manufacturer's Association, Wiring Devices—Dimensional Standards, National Electrical Manufacturer's Association (NEMA), 2002. This NEMA configuration has two phase conductors, and a neutral conductor, and no ground conductor (FIG. 2). Timers, lights and other functions not responsible for heating the food or drying the clothes are 120 V devices connected between neutral and one of the phase conductors. The heating elements are 240V devices connected between the two phase conductors. There is no equipment ground conductor on NEMA 10-30 and 10-50 outlets. Manufacturers building equipment using such connectors are required to bond the frame of the equipment to neutral. Anyone touching a dryer or stove would be touching the neutral conductor. As the neutral conductor is nominally at a potential of zero volts, there would be no current flow through the person. However, while touching the washer or dryer, if the person comes in contact with a line conductor, the person or other living being would be in contact with two circuit conductors, and exposed to a serious electrical hazard.

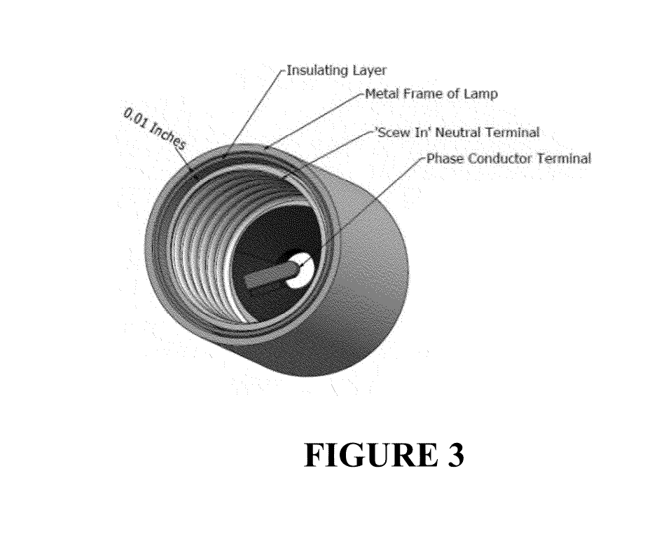

The standard screw in base lamp holder uses the screw in portion as the neutral terminal while the phase conductor terminal is at the bottom (FIG. 3). UL requires only a 0.01 inch thick insulating barrier made of glass reinforced tape or paper between the screw in neutral terminal and the outer metal shell of the light. Underwriters Laboratories Inc, Portable Electric Luminaires, Underwriters Laboratories Inc, 2011. The lamp is then connected to power via a NEMA 1-15 plug (2 pin, without a ground). If the insulating material is damaged, the metal of the lighting fixture may come in contact with screw neutral terminal. A person touching the lamp and coming into contact with another conductor will be subject to a two circuit conductor fault, and exposed to a serious electrical hazard.

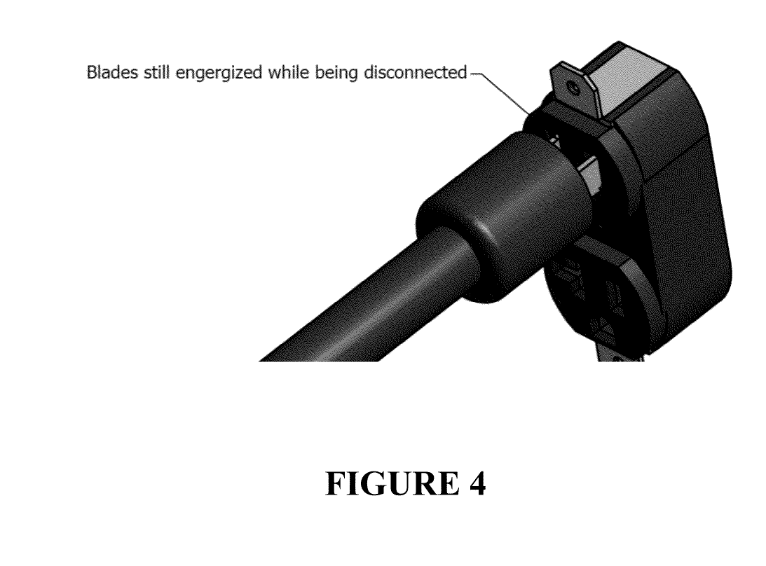

When removing NEMA 1-15 or 5-15 plug from an outlet, there is a risk of coming into contact with the blades of the wiring device (FIG. 4). Someone with small hands, such as a child, attempting to remove a plug from the wall, risks coming into contact with both blades (the line conductor and the neutral conductor) at the same time.

There is a need for a new type of device to detect a person coming into contact with two circuit conductors. Unlike the “leakage” fault that a GFCI detects, the new device would detect a person as a load on the circuit. Moreover, there is a need for a device to evaluate the load characteristics of the circuit, and disconnect power if a human load is detected.

### SUMMARY OF THE INVENTION

Disclosed herein are devices and methods that provide personal protection against electrical shock hazards involving two circuit conductors, and various aspects thereof. The devices and methods disclosed herein may have additional benefits and applications in other fields than those specifically discussed herein, and may obtain objectives not specifically set forth below.

One objective of the present invention is to provide a device that recognizes and evaluates the load characteristics of electrical equipment. Another objective is to provide a learning device that continuously evaluates the load characteristics using a signal processing device. The device can detect whether the load is unknown to the system and, if desired, can disconnect the power.

In one embodiment the invention relates to an apparatus for protecting against faults in electrical loads connected to a power supply, the apparatus comprising: a memory; a signal processing device comprising logic for measuring the load characteristics of a load connected to the power supply, logic for determining if the load characteristics of the load connected to the power supply substantially match one or more load characteristics previously stored in the memory, and logic for selectively generating a control signal in response to whether the load characteristics of the electrical load substantially match the load characteristics stored in the memory; and, if desired, a switch coupled to the signal processing device for selectively interrupting the supply of power from the power supply in response to the control signal generated by the signal processing device.

In another embodiment the invention relates to an apparatus for protecting against faults in electrical equipment connected to a power supply, the apparatus comprising: a memory; means for measuring the load characteristics of an electrical load connected to the power supply; comparison means for determining if the load characteristics of the electrical load substantially match the load characteristics stored in the memory; means for generating a control signal based on the comparison of the load characteristics of the electrical load to the load characteristics stored in memory; and, if desired, means for interrupting the supply of power from the power supply in response to the control signal.

In yet another embodiment, the present invention relates to a method for protecting against faults in electrical equipment coupled to a power supply, the method comprising: measuring the load characteristics of a load connected to the power supply; determining if the load characteristics of the load connected to the power supply substantially match one or more load characteristics previously stored in a memory; interrupting the supply of power from the power supply in response based on determination of whether the load characteristics of the load connected to the power supply substantially match one or more load characteristics previously stored in the memory.

In another embodiment, the invention relates to a method for protecting against faults in electrical equipment coupled to a power supply, the method comprising: creating a library of load characteristics of electrical loads that may be connected to the power supply; measuring the load characteristics of an electrical load connected to the power supply; determining if the measured load characteristics substantially match one or more of the load characteristics in the library of load characteristics; and selectively interrupting the supply of power from the power supply in response to the determination of whether the measured load characteristics substantially match one or more of the load characteristics in the library of load characteristics.

Yet another objective is to utilize the processes and algorithms of the present invention in applications beyond circuit protection, such as, for example, end-of-life indicators, or monitoring for unauthorized use, industrial safety.

Other embodiments, objects, features and advantages will be set forth in the detailed description of the embodiments that follows, and in part will be apparent from the description, or may be learned by practice, of the claimed invention. These objects and advantages will be realized and attained by the processes, devices and components particularly pointed out in the written description and claims hereof. The foregoing summary has been made with the understanding that it is to be considered as a brief and general synopsis of some of the embodiments disclosed herein, is provided solely for the benefit and convenience of the reader, and is not intended to limit in any manner the scope or range of equivalents, to which the appended claims are lawfully entitled.

### REFERENCE TO COLOR DRAWINGS

This application file contains at least one drawing executed in color. Copies of this patent application publication with color drawings will be provided by the Office upon request and payment of the necessary fee.

### BRIEF DESCRIPTION OF THE DRAWINGS

The present invention is described in detail below with reference to the attached drawings and figures, wherein:

FIG. 1 is a diagram representing a single conductor fault to ground through a person, according to the prior art;

FIG. 2a is a diagram showing the mentioned NEMA style connectors and FIG. 2b is an example of labeling present on older model stoves;

FIG. 3 is a illustration of a lamp socket without a ground wire, which presents anelectrical fault risk;

FIG. 4 is an illustration of a NEMA style connector having a partial connection to an outlet, showing exposed energized blades on the connector which present an electrical fault risk;

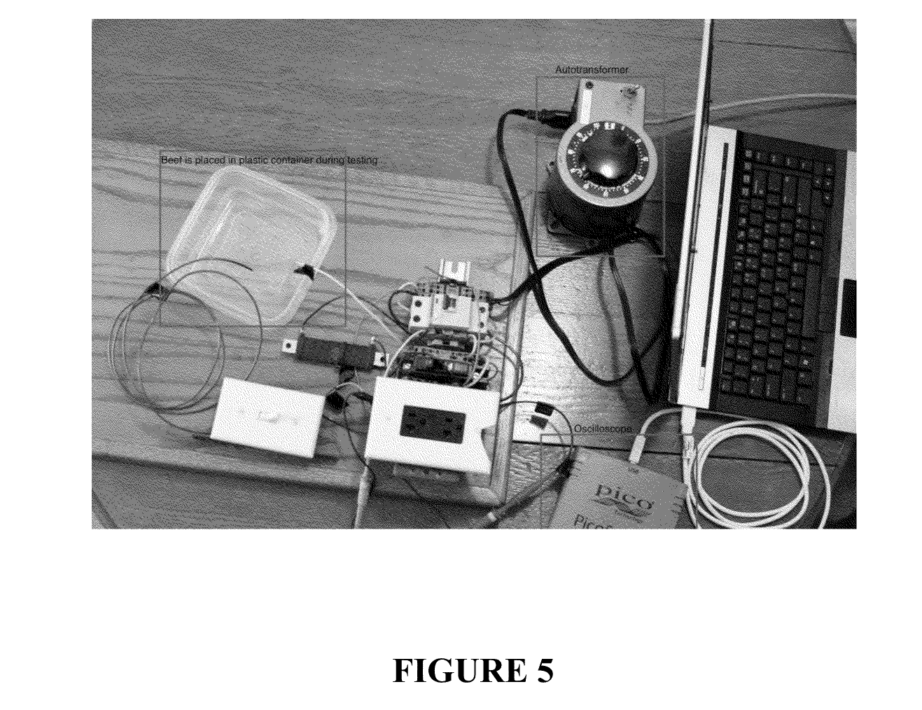

FIG. 5 is a diagram showing a test setup for evaluating fault protection devices and methods, according to an embodiment of the invention;

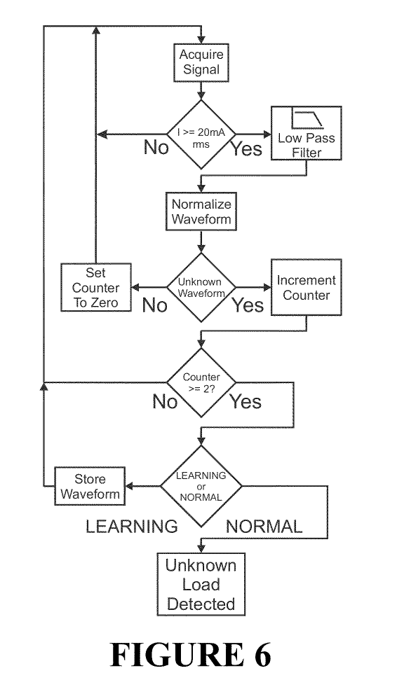

FIG. 6 is a flowchart diagram showing a method for detecting an unknown load connected to a circuit, and thus determining the existence of a possible electrical fault, according to an embodiment of the invention;

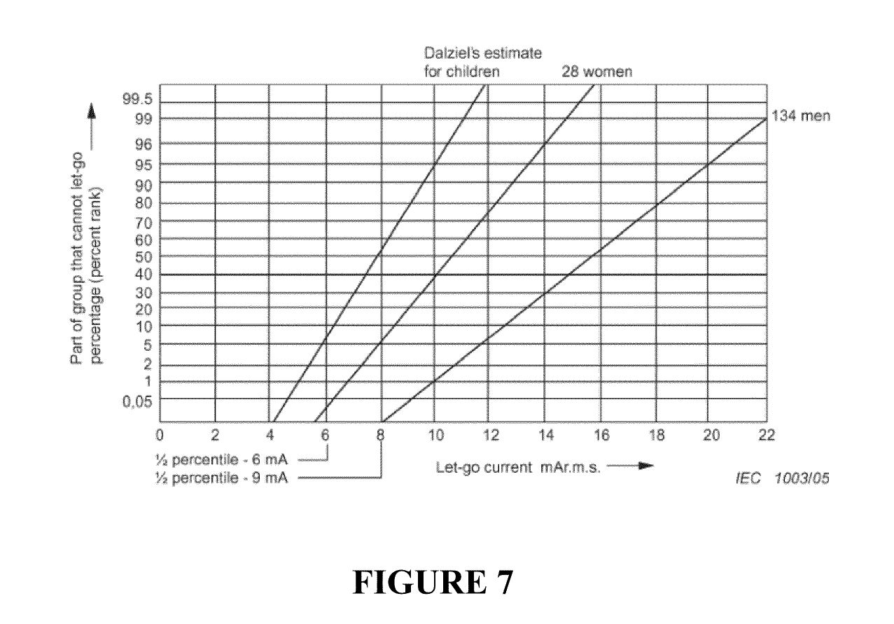

FIG. 7 is a chart showing the “let go” current threshold under certain conditions;

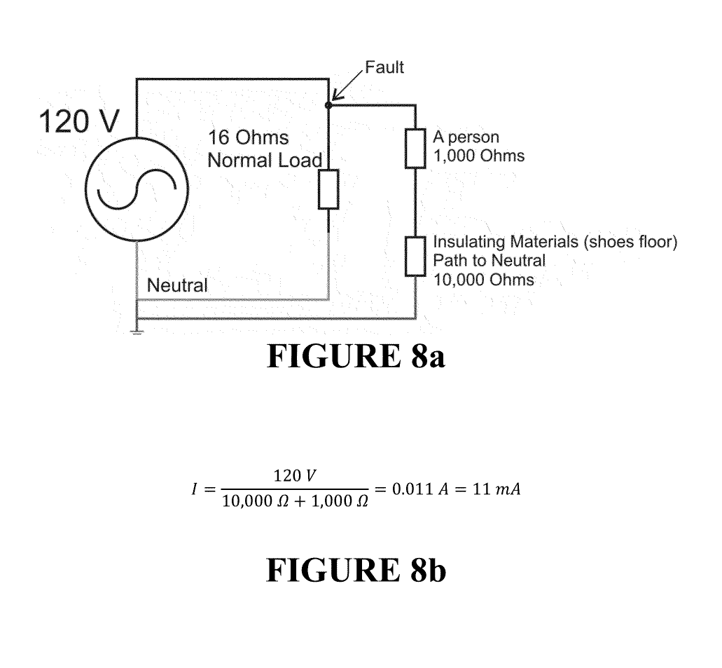

FIG. 8a is a diagram showing the electrical circuit characteristics of an individual coming into contact with a single line conductor, and FIG. 8b is the corresponding equation showing the current flowing through an individual in the diagram of FIG. 8a;

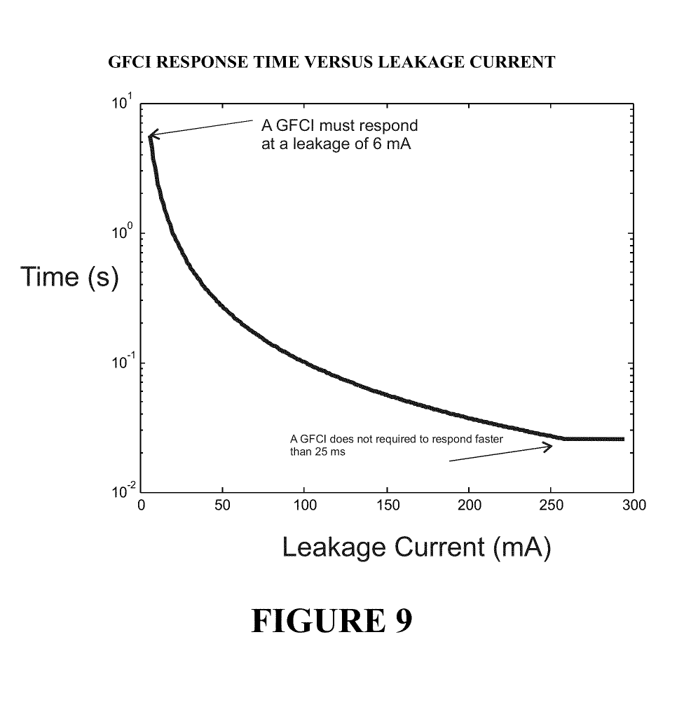

FIG. 9 is a chart showing the average required response time performance for a GFCI as a function of leakage current;

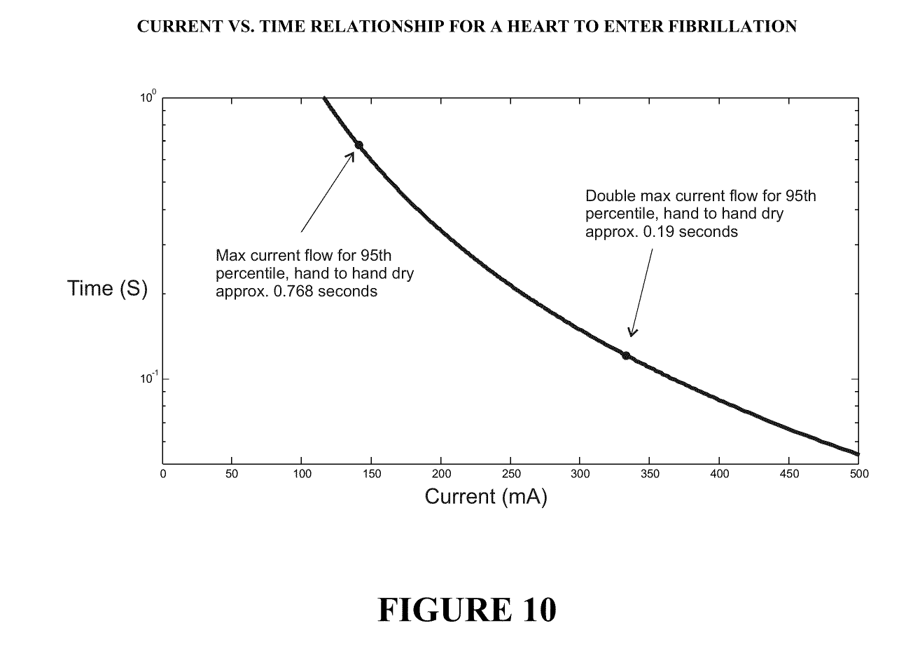

FIG. 10 is a chart showing the average minimum time for a human heart to go into fibrillation based on experimental data;

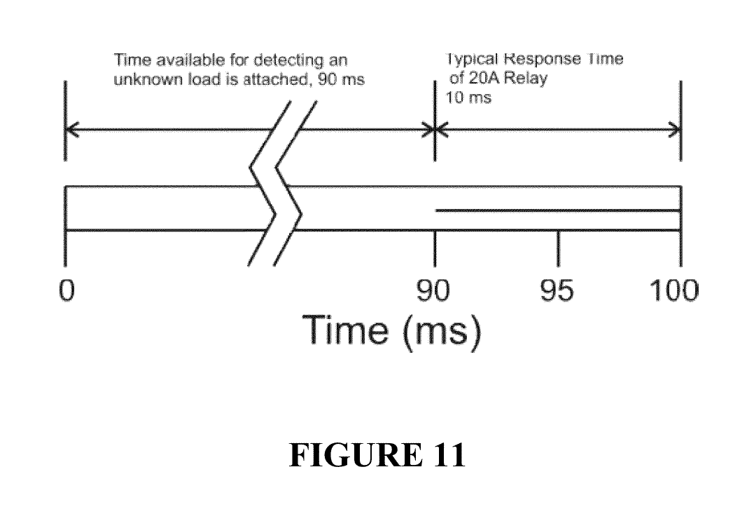

FIG. 11 is a chart showing the timing available for a GFCI to detect a unknown load for fault detection purposes based on a given typical response time for a relay to be actuated;

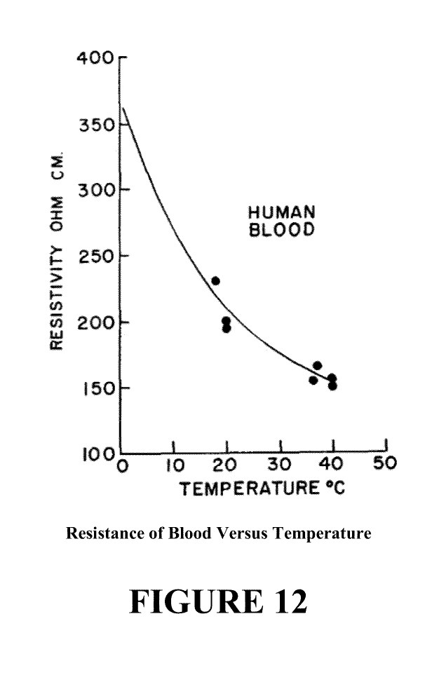

FIG. 12 is a chart showing the electrical resistance (or impedance) of human blood as a function of temperature;

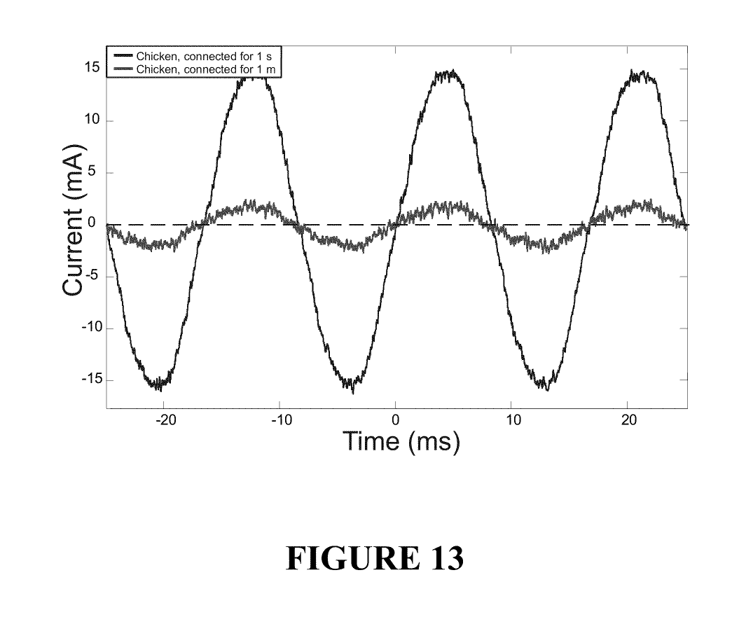

FIG. 13 is a graph showing the differences in current drawn in a piece of chicken after 1 second of connection to a voltage source, and after 1 minute of connection to a voltage source;

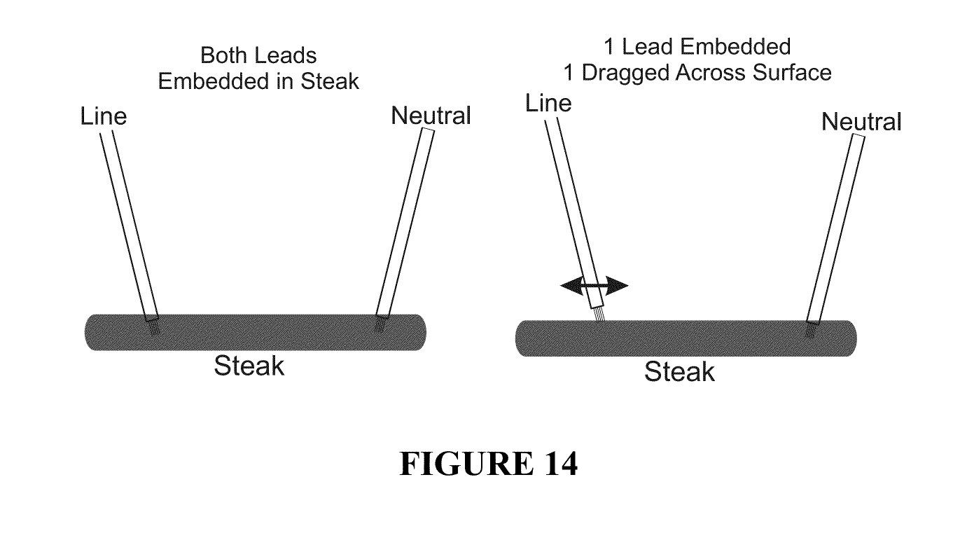

FIG. 14 is an illustration showing probe connections between two circuit conductors and a load;

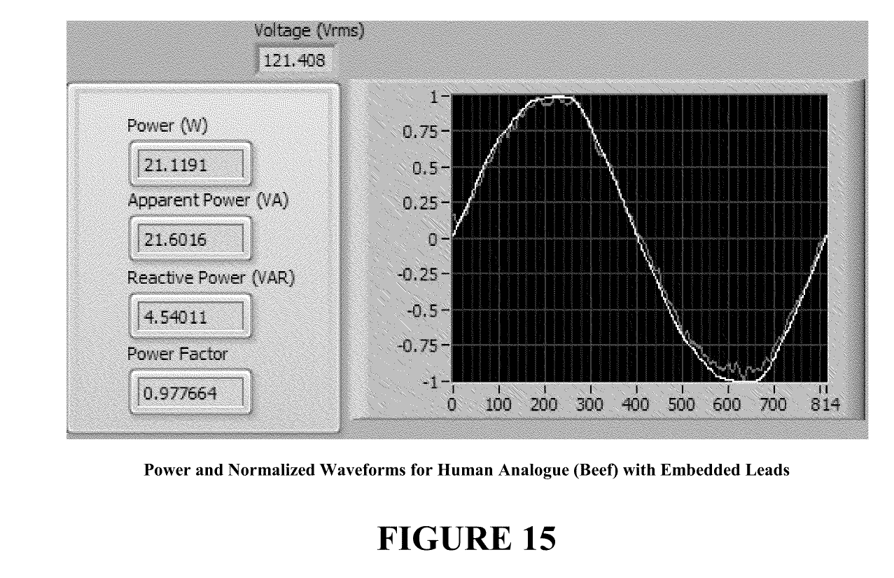

FIG. 15 is a graph showing the power and normalized waveforms for a beef load connected via embedded leads;

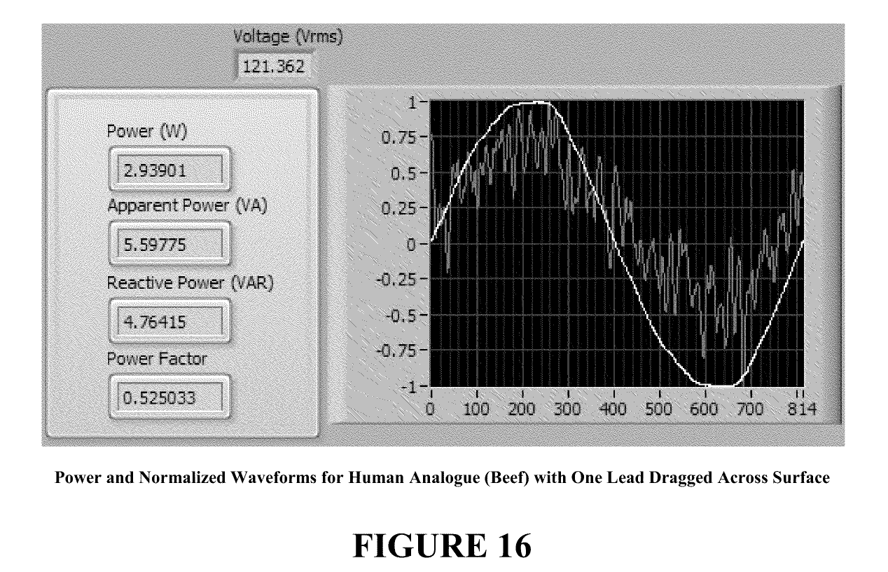

FIG. 16 is a graph showing the power and normalized waveforms for a beef load connected via one embedded lead, and a second lead dragged across the surface;

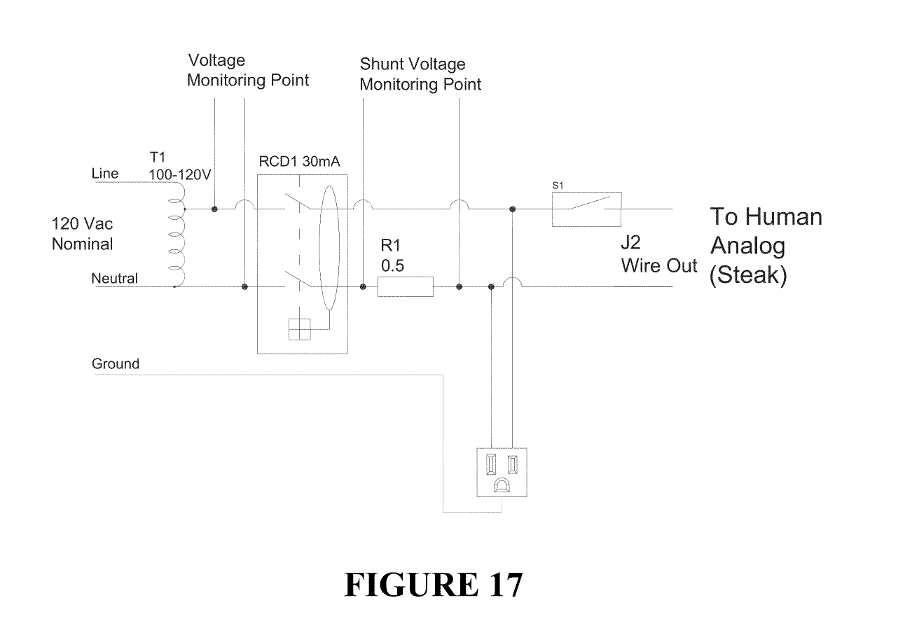

FIG. 17 is a schematic illustration of a test setup for allowing the connection and disconnection of loads;

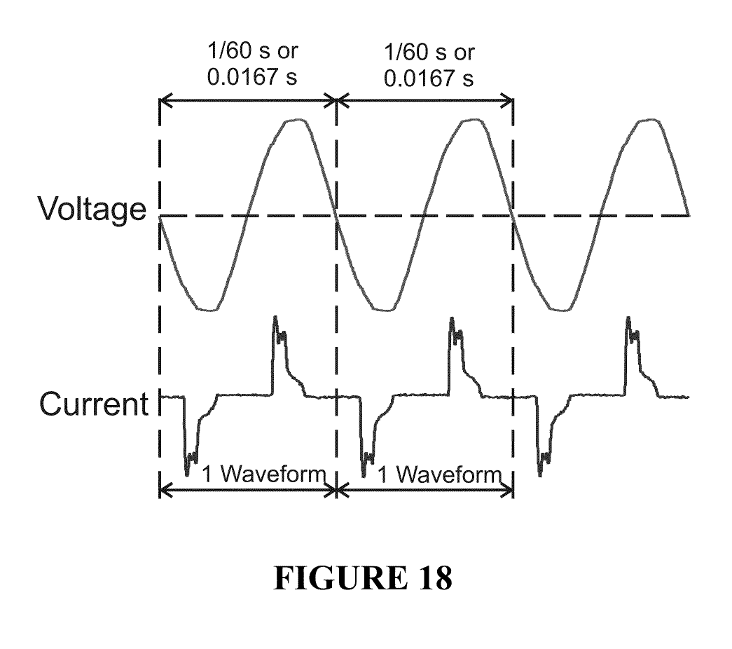

FIG. 18 is a graph showing the current waveforms for a compact fluorescent light bulb (CFL), based on voltage signal;

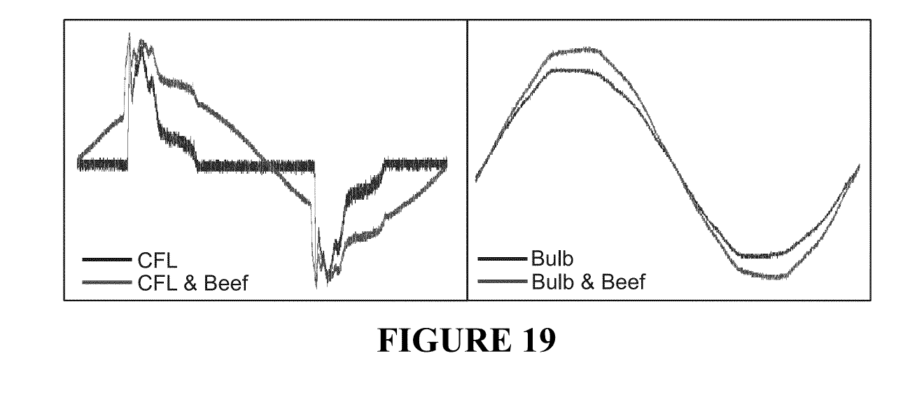

FIG. 19 is a graph showing the current waveforms for (i) a CFL light bulb with and without a beef load connected in parallel and (ii) an incandescent blub with and without a beef load connected in parallel;

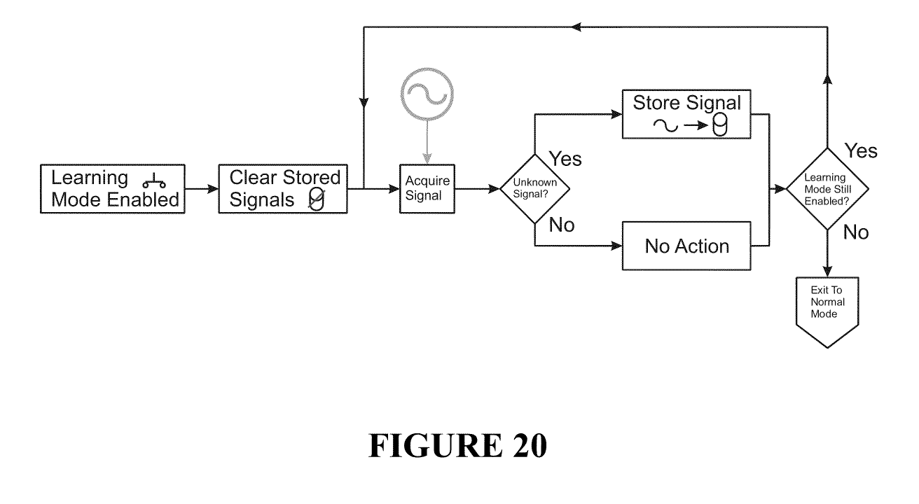

FIG. 20 is a flowchart diagram showing a method for learning current waveforms for loads attached to a protection device, used by a fault protection device operating in a “Learning Mode,” according to an embodiment of the invention;

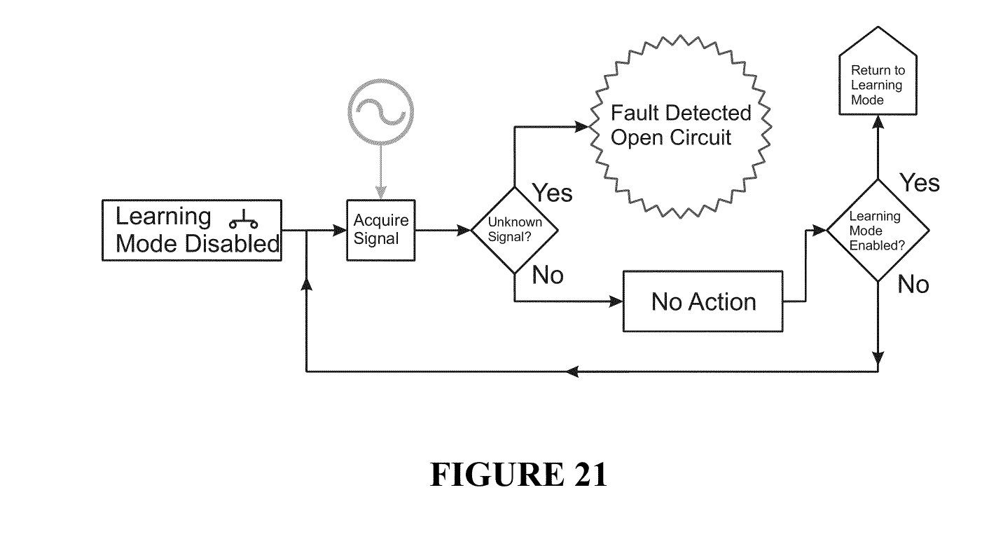

FIG. 21 is a flowchart diagram showing a method for detecting a potential electrical fault by comparing incoming waveforms to stored waveforms, used by a fault protection device operating in a “Protection Mode” (or “Normal Mode”), according to an embodiment of the invention;

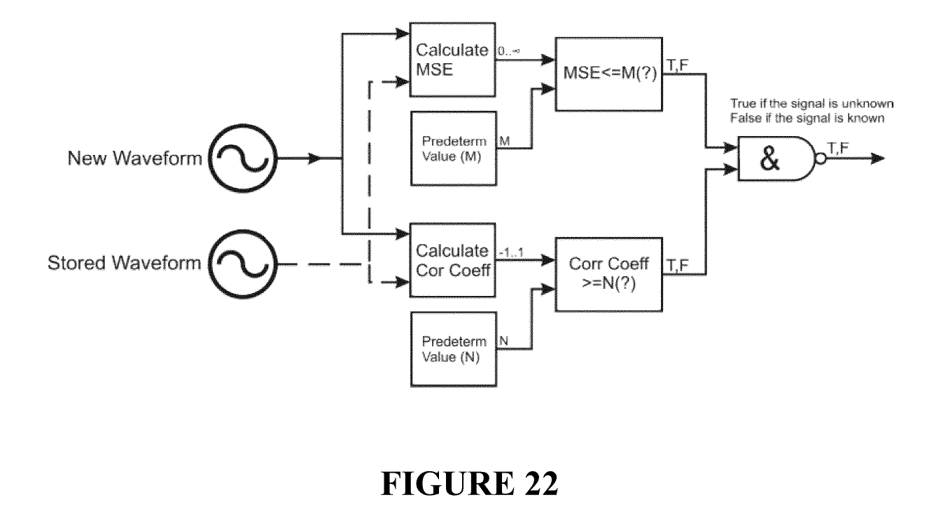

FIG. 22 is a flowchart schematic diagram illustrating a method for evaluating a incoming waveform in comparison to a stored waveform for the purposes of detecting a potential electrical fault, according to an embodiment of the invention;

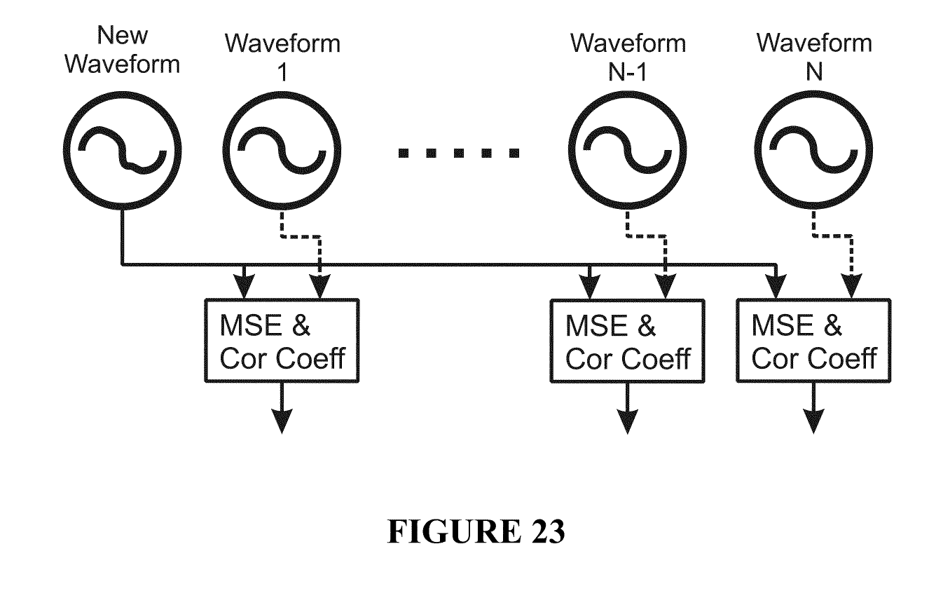

FIG. 23 is a flowchart schematic diagram illustrating a method for evaluating a incoming waveform in comparison to multiple stored waveforms for the purposes of detecting a potential electrical fault, according to an embodiment of the invention;

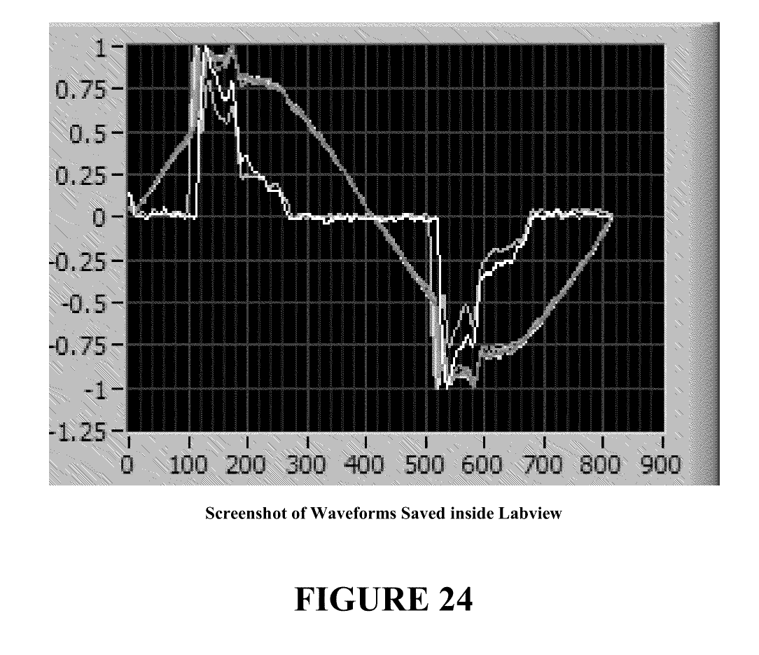

FIG. 24 is a graph showing stored waveforms for an incandescent light bulb and for a compact fluorescent light bulb (CFL), according to an embodiment of the invention;

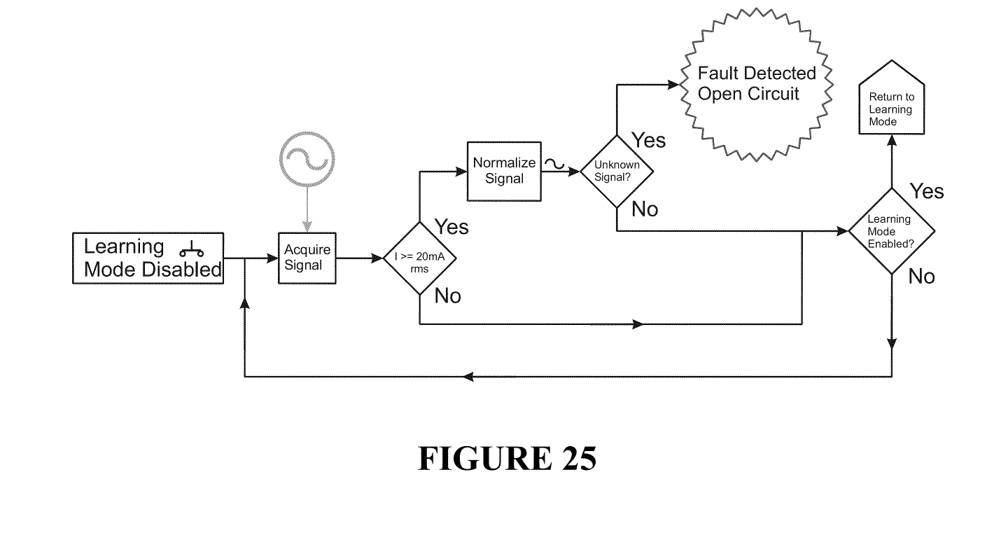

FIG. 25 is a flowchart diagram showing a method to detect a potential electrical fault for a device operating in a “Protection Mode” (or “Normal Mode”) having a minimum current draw detection step, according to an embodiment of the invention;

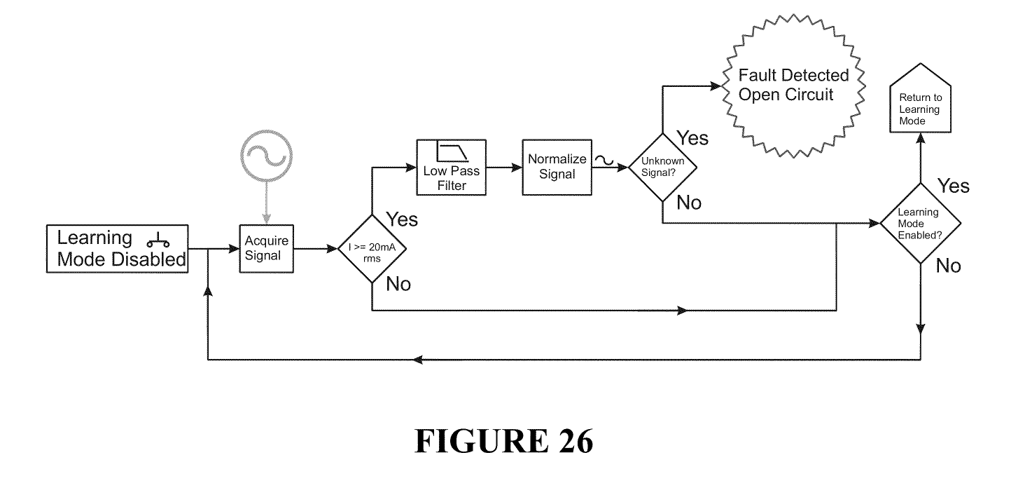

FIG. 26 is a flowchart diagram showing a method to detect a potential electrical fault for a device operating in a “Protection Mode” (or “Normal Mode”) having low pass filtering, according to an embodiment of the invention;

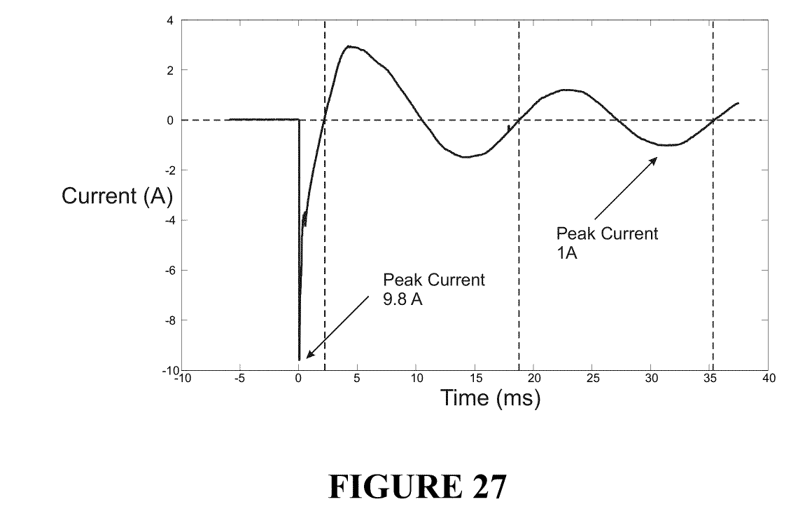

FIG. 27 is a graph showing the current draw of an incandescent light bulb being turned on over time;

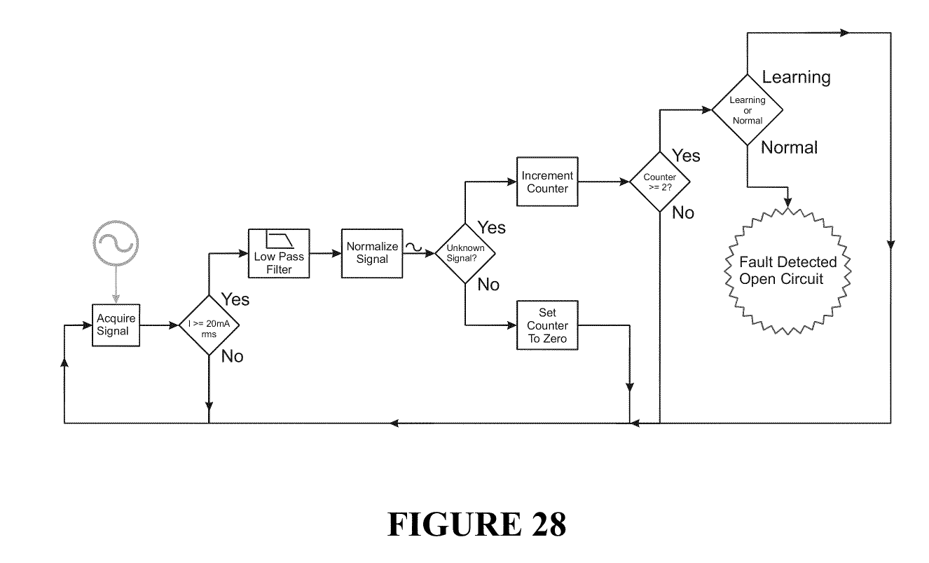

FIG. 28 is a flowchart diagram showing a method implemented by a device having a “Learning Mode” and a “Normal Mode” (or “Protection Mode”) to detect an unknown load connected to a circuit, and thus determine the existence of a possible electrical fault, according to an embodiment of the invention;

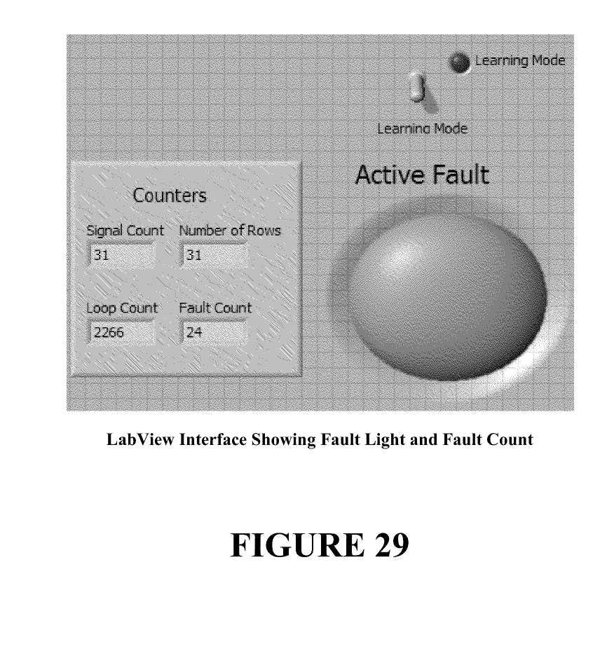

FIG. 29 is a illustration of a visual interface for determining the presence and number of detected faults, according to an embodiment of the invention;

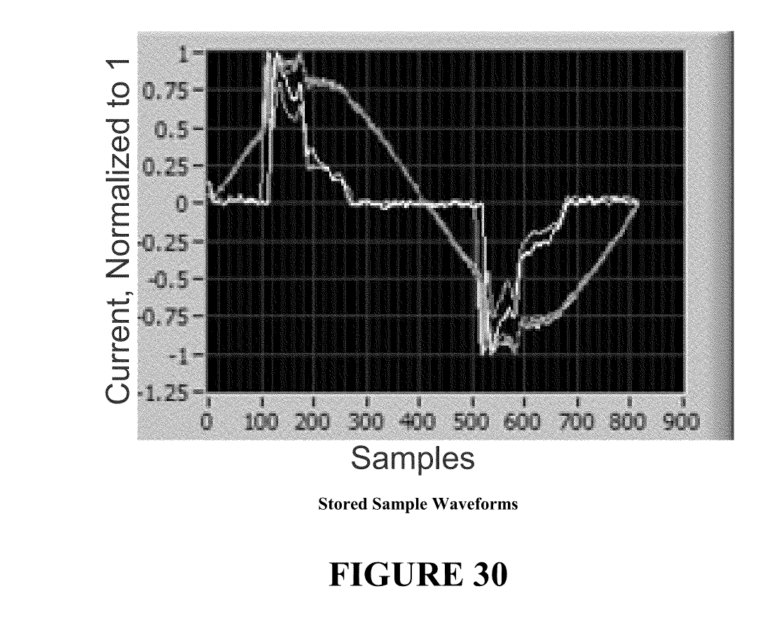

FIG. 30 is an illustration of stored current waveform signals from an incandescent light bulb and a CFL acquired by the device during Learning Mode, according to an embodiment of the invention;

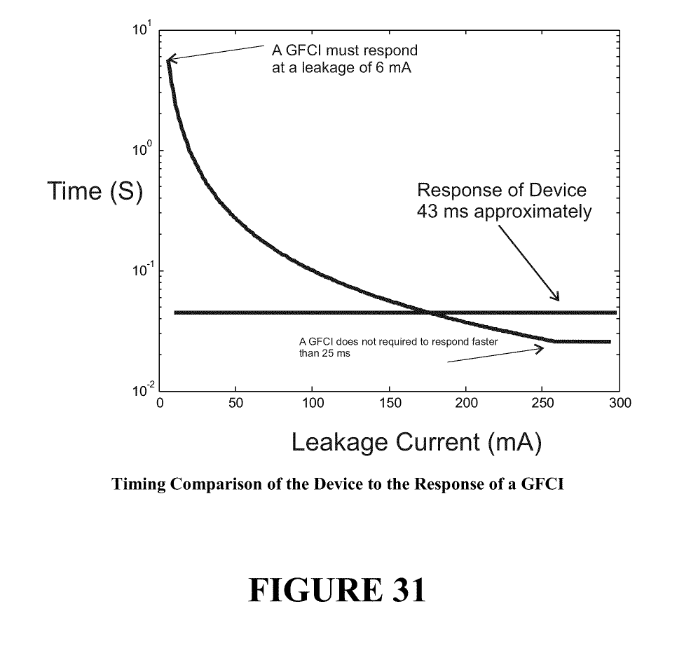

FIG. 31 is a chart showing the response time requirements for an electrical fault protection devices;

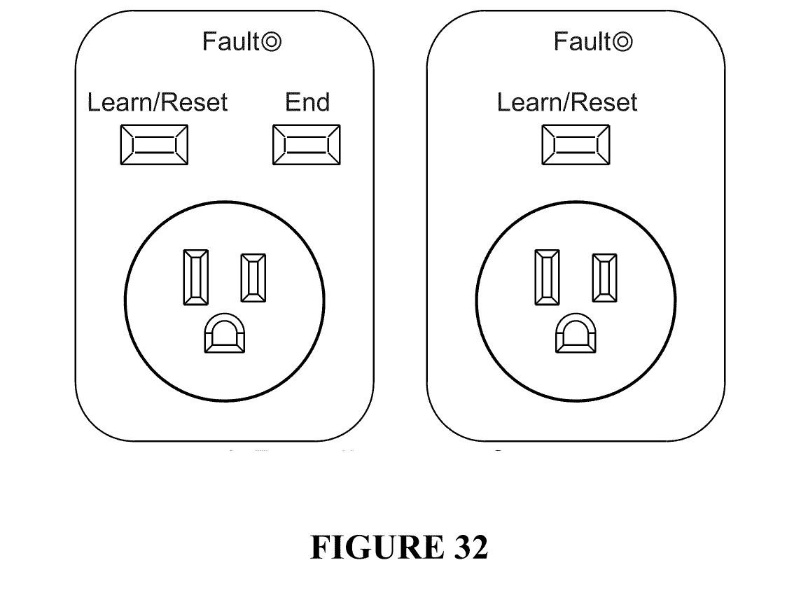

FIG. 32 is an illustration of exemplary electrical socket receptacles having interfaces with controls to place the device in a Learning Mode or Normal Mode, according to an embodiment of the invention;

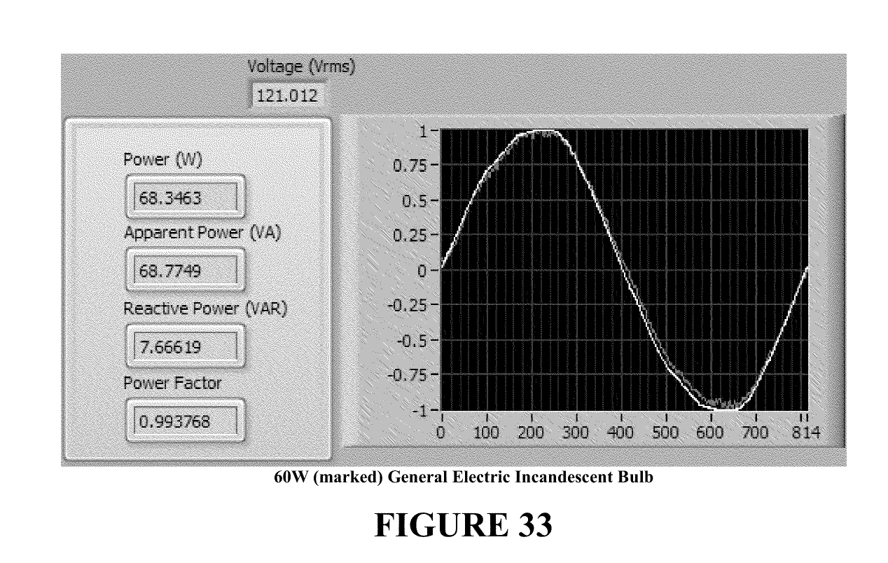

FIG. 33 is a graph showing the current waveform measured for a 60 W General Electric incandescent light bulb, according to an embodiment of the invention;

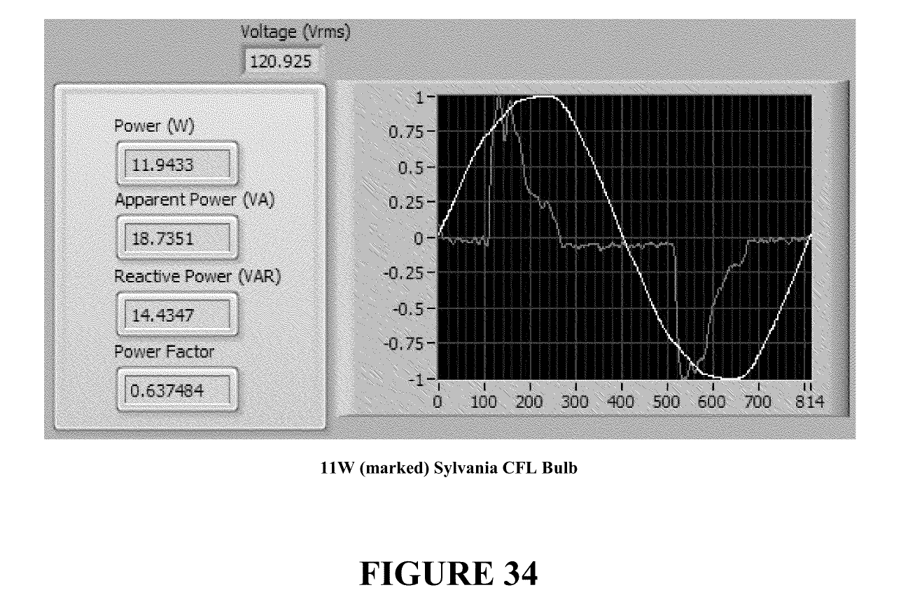

FIG. 34 is a graph showing the current waveform measured for an 11 W Sylvania CFL bulb, according to an embodiment of the invention;

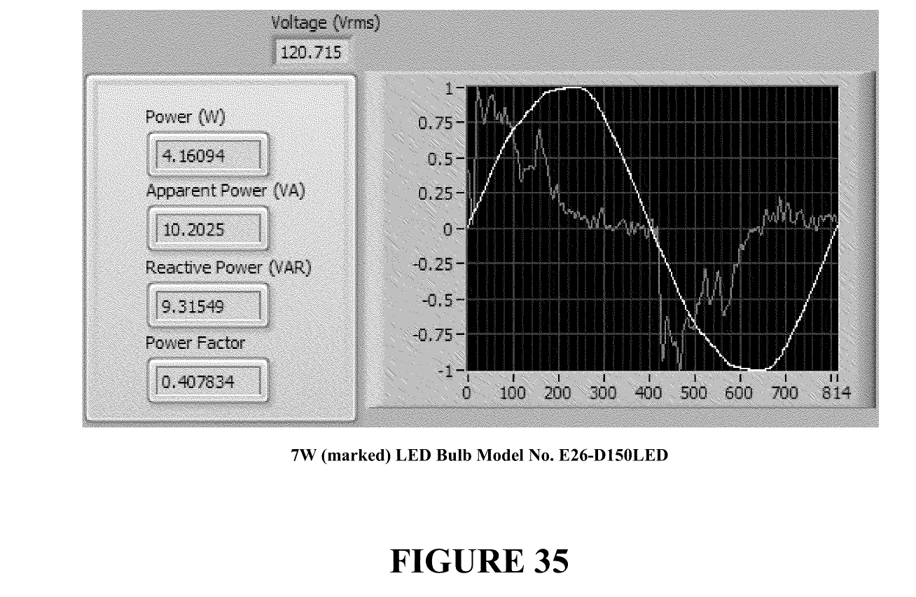

FIG. 35 is a graph showing the current waveform measured for a 7 W Model E26-D150LED LED bulb, according to an embodiment of the invention;

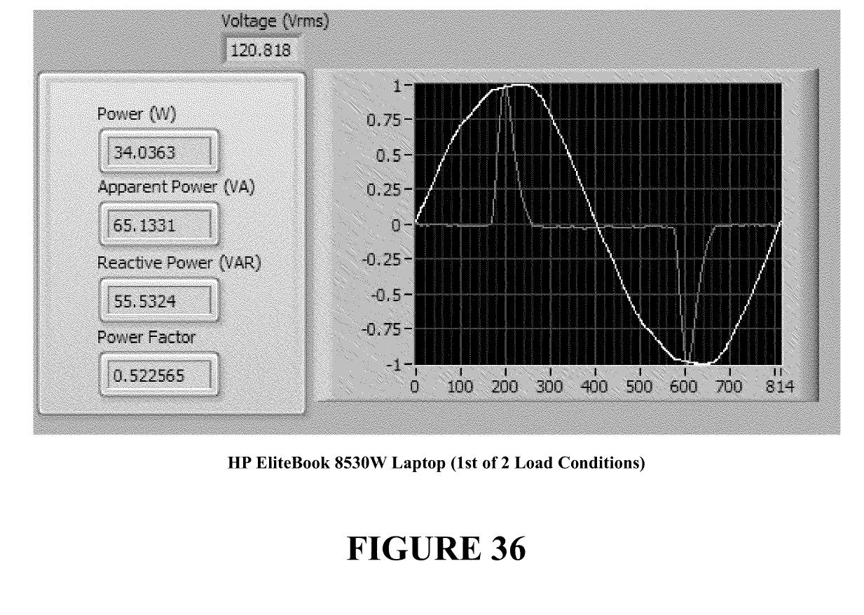

FIG. 36 is a graph showing the current waveform measured for an HP laptop, model Elitebook 8530w, under the first of two load conditions, according to an embodiment of the invention;

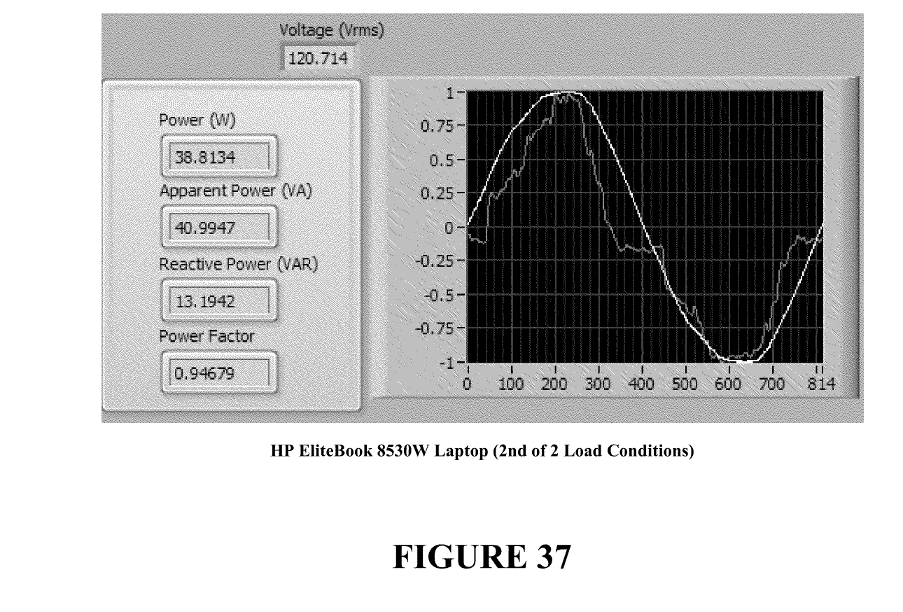

FIG. 37 is a graph showing the current waveform measured for an HP laptop, model Elitebook 8530w, under the second of two load conditions, according to an embodiment of the invention;

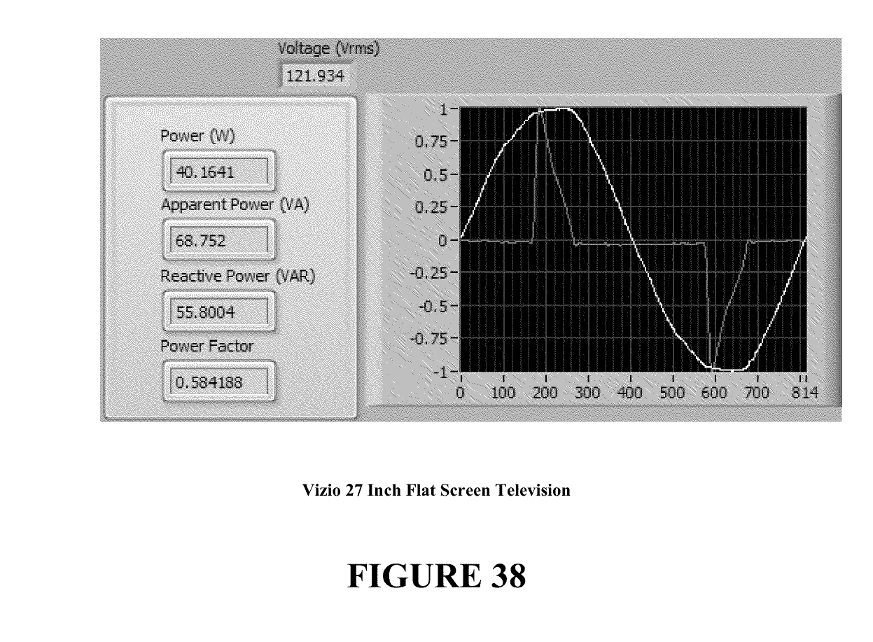

FIG. 38 is a graph showing the current waveform measured for a 27-inch Vizio flat screen television, according to an embodiment of the invention;

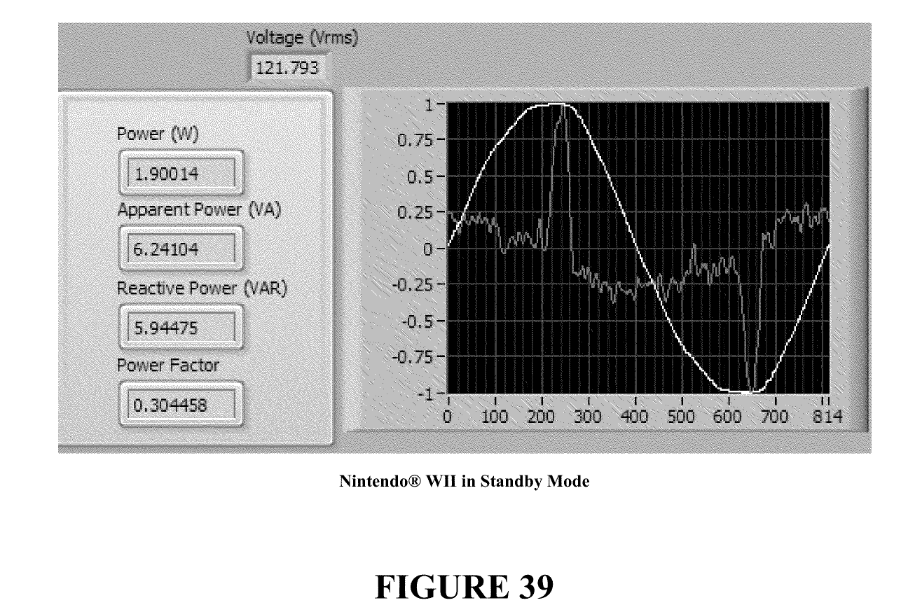

FIG. 39 is a graph showing the current waveform measured for a Nintendo Wii in standby mode, according to an embodiment of the invention;

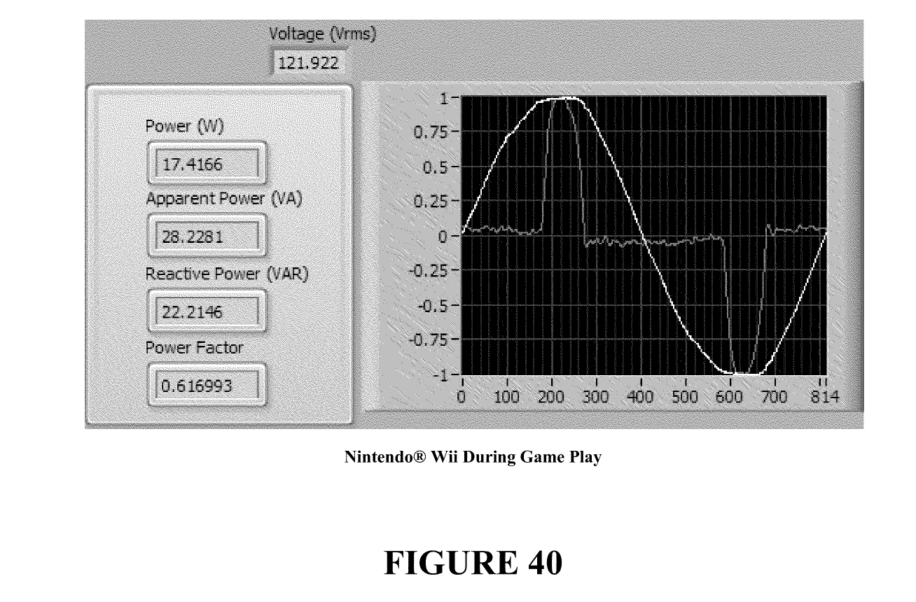

FIG. 40 is a graph showing the current waveform measured for a Nintendo Wii in during game play mode, according to an embodiment of the invention;

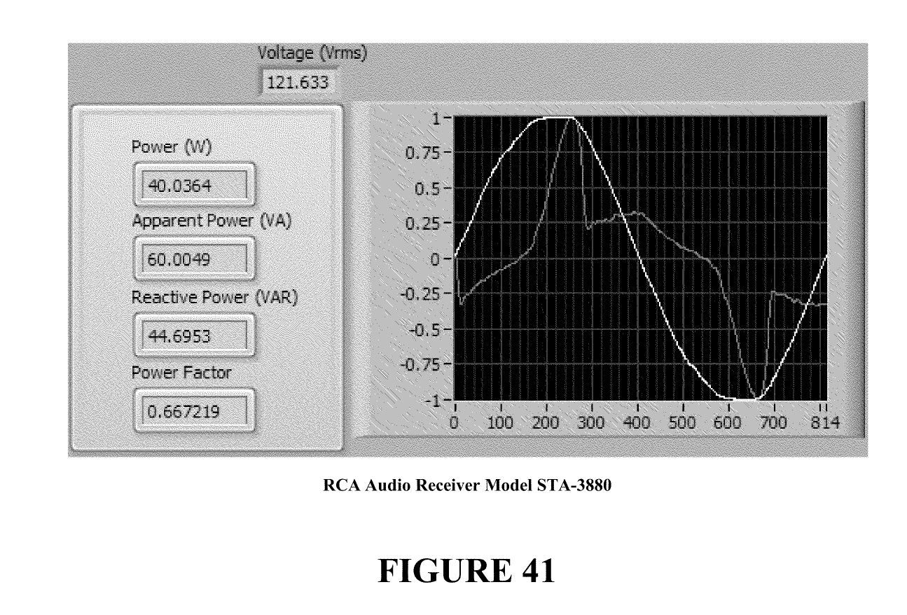

FIG. 41 is a graph showing the current waveform measured for an RCA Model STA-3880 audio receiver, according to an embodiment of the invention;

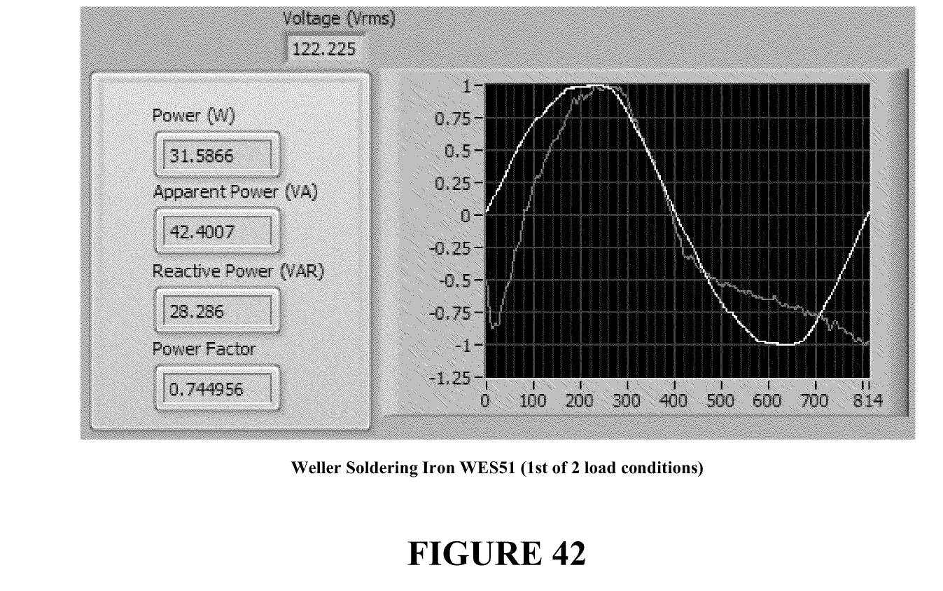

FIG. 42 is a graph showing the current waveform measured for a Weller soldering iron, model no. WE551, under the first of two load conditions, according to an embodiment of the invention;

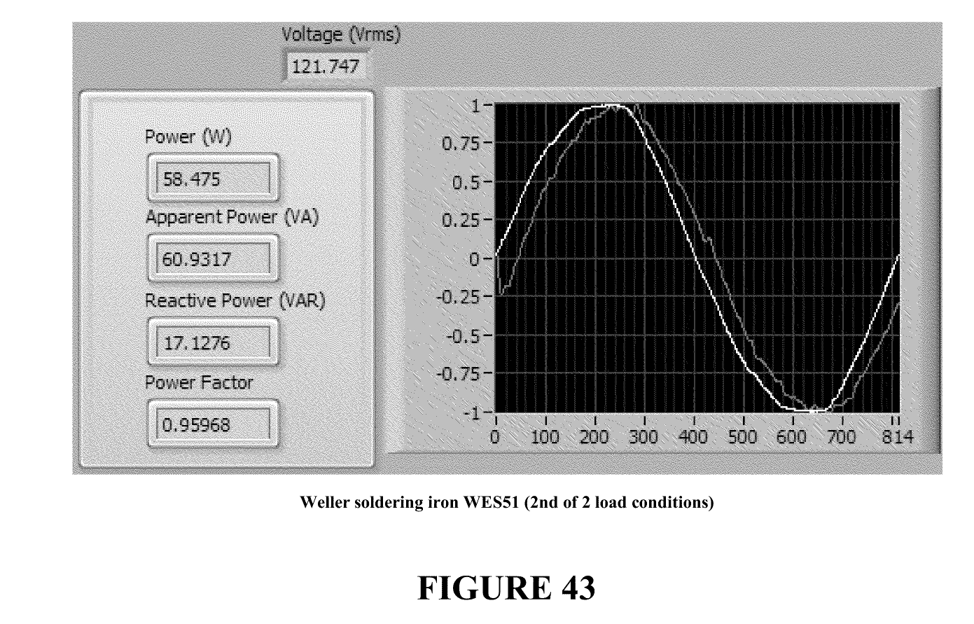

FIG. 43 is a graph showing the current waveform measured for a Weller soldering iron, model no. WE551, under the second of two load conditions, according to an embodiment of the invention;

FIG. 43 is a graph showing the current waveform measured for a human analogue load (beef) using two embedded leads, according to an embodiment of the invention;

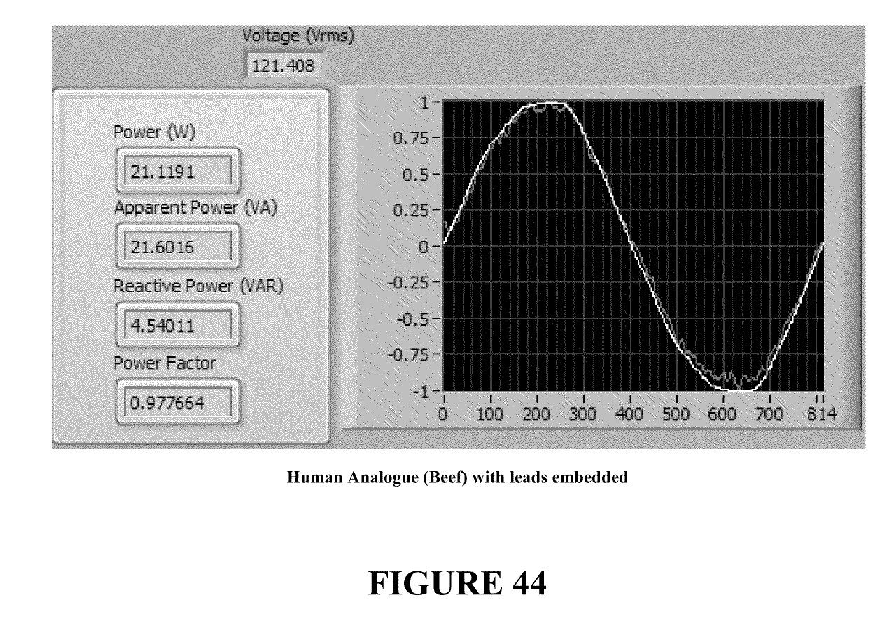

FIG. 44 is a graph showing the current waveform measured for a human analogue load (beef) using one embedded lead, and a second lead dragged across the surface, according to an embodiment of the invention;

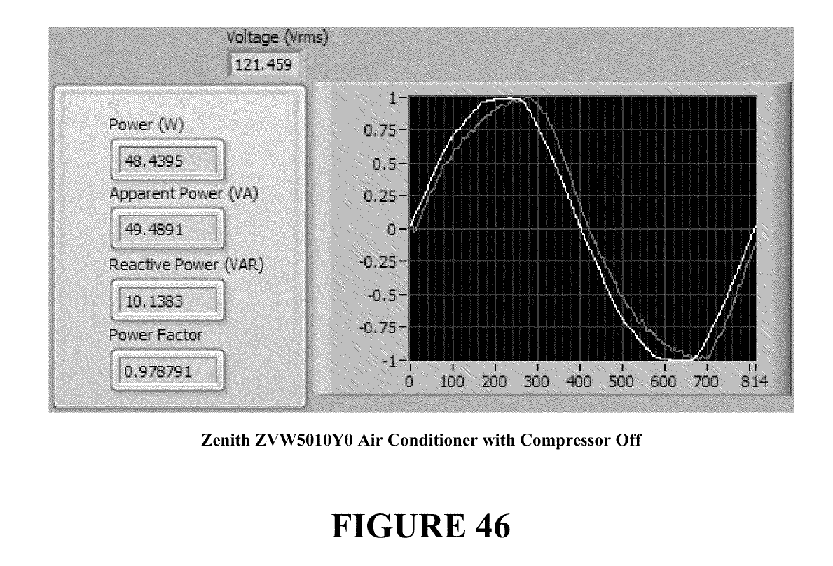

FIG. 46 is a graph showing the current waveform measured for a Zenith air conditioner, model no. ZVW5010Y0 with the compressor off, according to an embodiment of the invention;

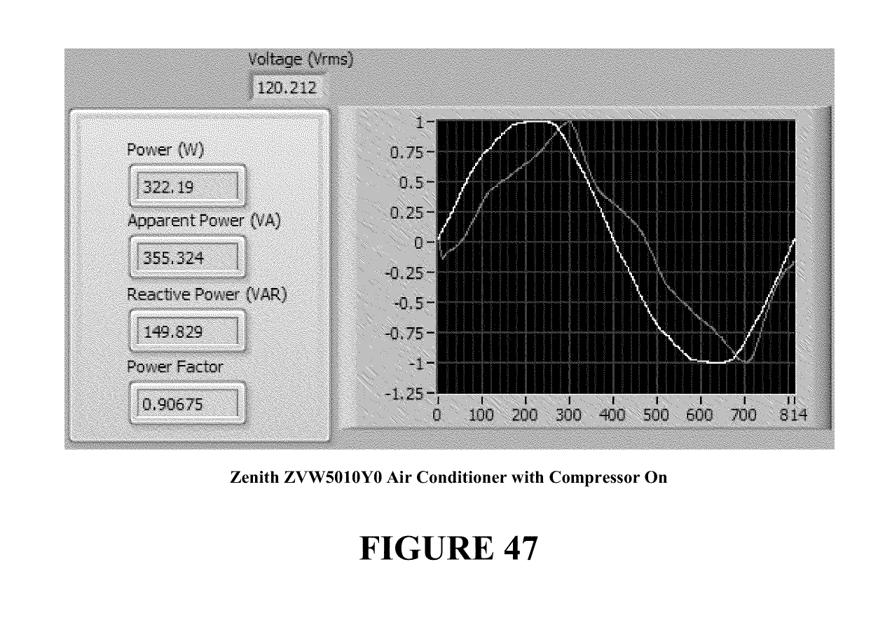

FIG. 47 is a graph showing the current waveform measured for a Zenith air conditioner, model no. ZVW5010Y0 with the compressor on, according to an embodiment of the invention.

### DETAILED DESCRIPTION

While the present invention is capable of being embodied in various forms, the description below of several embodiments is made with the understanding that the present disclosure is to be considered as an exemplification of the claimed subject matter, and is not intended to limit the appended claims to the specific embodiments described herein. The headings used throughout the disclosure are provided for convenience only and are not to be construed to limit the claims in any way. The various embodiments disclosed herein may be combined with other embodiments for the creation and description of yet additional embodiments. It will be apparent to one of ordinary skill in the art that the invention may be practiced without limitation to these specific details. In other instances, well-known methods and structures have not been described in detail so as not to unnecessarily obscure the invention.

The following non-limiting definitions are used herein to describe certain aspects of the present invention. In the following non-limiting definitions, both singular and plural forms of all terms fall within each meaning Except where noted otherwise, capitalized and non-capitalized forms of all terms fall within each meaning:

Circuit Conductor

Any conductor designed to carry current under normal conditions

Line Conductor

Any circuit conductor not intentionally connected to ground. Line conductors are also referred to as an ungrounded circuit conductors or phase conductors in multi-phase grounded power systems.

Separately Derived System

An electrical system not directly connected to any other electrical system. A separately derived system includes a system derived on the secondary side of an isolation transformer, or the system created by a generator.

Neutral Conductor

A circuit intentionally connected to ground at the neutral point of a separately derived system, may be referred to as the grounded circuit conductor.

Neutral Point

The midpoint of a power system, where the neutral conductor is normally connected to the ground conductor.

Ground Conductor

Conductor not normally meant to carry current that connects other metallic objects not normally meant to carry current. It is designed to provide a low impedance path for fault current back to the neutral point. It may be referred to as the equipment grounding conductor, or the protective earth conductor. The conductor is bonded to earth typically through electrode(s).

Ground

The earth.

Grounded Power System

A power system where one or more of the circuit conductor(s) are bonded to ground.

Ungrounded Power System

Any power system where none of the circuit conductors are connected to ground either intentionally or unintentionally. The most common form a person will come into contact with is a delta power system located on board a ship where there is no connection to earth.

In one embodiment, the present invention operates on three phase or single phase circuits of different voltages, and current ratings. One embodiment has been developed with 120V, 60 Hz circuits commonly found in residential, commercial, and industrial facilities in North America. An exemplary implementation has been done in LabVIEW system design software available from National Instruments. Signal captures were captured via an oscilloscope where it illuminated an indicator when a fault was detected. In one embodiment, the present invention employs the following equipment:
Power source capable of providing at least 12 A at 120 V 60 Hz
Variac or adjustable transformer capable of adjustment between 120V-110V
RCD, switch, or other device to allow safe connection to power leads
Shunt Resistor, 0.5Ω, rated for at least 25 W
Switch for disconnecting the human analogue from the circuit
Wire connection for human analogue load
Beef for load testing
Output receptacle for connecting most loads

Such equipment may be assembled as shown in FIG. 5.

In one embodiment, the storage and processing of waveforms takes place using LabVIEW software, which was customized to accomplish the following. The data of the waveforms are captured by a USB-connected Pico brand oscilloscope, and are stored in a text based array or spreadsheet type file, which is saved or exported like an Excel spreadsheet. The LabVIEW software compares the incoming waveforms to the stored waveforms in the array, and makes the calculations of correlation coefficient and mean square error. LabVIEW can be turned into a full deployment system, although these functions can be performed by digital integrated circuits, and digital signal processors with a small amount of storage memory (like flash) for the learned waveforms. The method is analogous to how digital data communications happen using correlators and comparators, or for Wi-Fi or Bluetooth in something smaller than a USB memory stick. In another embodiment, the process will be performed on a single chip, or small electronics board.

In another embodiment, a commercially available digital signal processor (DSP) along with some commercially available integrated circuits for voltage testing and waveform storage (like a look-up-table or flash memory chip) may be employed. Another alternative is an FPGA device which allows a custom program (like the one developed in LabVIEW) to be downloaded in a “hardware” version which could be plugged in to the necessary inputs and power supplies on a small PCB.

As Applicants' experiments, which are described below, established, the device and method of the present invention provide protection which is not provided by a GFCI. The tolerance was determined experimentally to provide accurate detection of faults, while avoiding false positives. Good results were obtained setting the correlation coefficient level to about 0.95 and the mean square error to about 0.1. This equates to there being a 95% match to the stored waveforms. However, the correlation coefficient can be changed fluidly in the LabVIEW program, or adjusted at anytime during use. In another embodiment, the tolerance is dynamic to accommodate different types of loads based on an initial measurement during the learning mode of the load characteristics.

In one embodiment, the invention relates to an apparatus for protecting against faults in electrical loads connected to a power supply, the apparatus comprising: a memory; a signal processing device comprising logic for measuring the load characteristics of a load connected to the power supply, logic for determining if the load characteristics of the load connected to the power supply substantially match one or more load characteristics previously stored in the memory, and logic for selectively generating a control signal in response to whether the load characteristics of the electrical load substantially match the load characteristics stored in the memory; and a switch coupled to the signal processing device for selectively interrupting the supply of power from the power supply in response to the control signal generated by the signal processing device.

Such apparatus may have the feature where the load characteristics correspond to a representation of the current drawn by a load over time, or where the logic for selectively generating the control signal generates the control signal if the load characteristics of the load connected to the power supply do match one or more of the load characteristics stored in the memory.

Such apparatus may further comprise an input control for placing the apparatus in a learning mode or a protection mode. The signal processing device may further comprise logic for causing the load characteristics of the load connected to the power supply to be stored in the memory if the apparatus is in the learning mode and if the load characteristics of the load connected to the power supply do not match one or more of the load characteristics stored in the memory. The logic for determining if the load characteristics of a load connected to the power supply may substantially match one or more load characteristics previously stored in the memory comprises logic for calculating whether the load characteristic matches using any number of comparative calculations including, but not limited to, the mean square error and the Pearson correlation coefficient. Other comparative calculations that may be used include, by way of example, Fourier analysis, Fast Fourier analysis, Wavelet analysis, and Auto Correlations analysis.

In addition, in one embodiment, the signal processing device may determine that two load characteristics match if the mean square error is greater than a first value, and if the Pearson correlation coefficient is less than a second value. Alternatively or additionally, the signal processing device may determine that two load characteristics match if the comparative analysis—such as Fourier analysis, Fast Fourier analysis, Wavelet analysis, and Auto Correlations analysis—results in a value indicating that two waveforms are substantially similar. This value for indicating that two waveforms are substantially similar may be achieved by way of routine testing, such as the methods described herein.

In another embodiment, herein described is an apparatus for protecting against faults in electrical equipment connected to a power supply, the apparatus comprising: a memory; means for measuring the load characteristics of an electrical load connected to the power supply; comparison means for determining if the load characteristics of the electrical load substantially match the load characteristics stored in the memory; means for generating a control signal based on the comparison of the load characteristics of the electrical load to the load characteristics stored in memory; and means for interrupting the supply of power from the power supply in response to the control signal. Such apparatus may have the feature wherein the load characteristics correspond to a representation of the current drawn by a load over time.

Additionally, the means for selectively generating the control signal generates the control signal if the load characteristics of the load connected to the power supply do match one or more of the load characteristics stored in the memory. The apparatus may further comprise means for placing the apparatus in a learning mode and an operational mode.

The apparatus may further comprise means for causing the load characteristics of the load connected to the power supply to be stored in the memory if the apparatus is in the learning mode and if the load characteristics of the load connected to the power supply do not match one or more of the load characteristics stored in the memory. Further, the apparatus may comprise means for calculating the mean square error and the Pearson correlation coefficient, or for using a different analysis (either alone or in combination with the mean square error and the Pearson correlation coefficient analysis) for performing a comparative analysis between stored and measured waveforms using, for example, Fourier analysis, Fast Fourier analysis, Wavelet analysis, or Auto Correlations analysis, or other methods known by those of ordinary skill in the art.

The comparison means may determine that two load characteristics match if the mean square error is greater than a first value, and if the Pearson correlation coefficient is less than a second value. Alternatively or additionally, the comparison means may determine that two load characteristics match if the comparative analysis—such as Fourier analysis, Fast Fourier analysis, Wavelet analysis, and Auto Correlations analysis—results in a value indicating that two waveforms are substantially similar. This value for indicating that two waveforms are substantially similar may be achieved by way of routine testing, such as the methods described herein.

In another embodiment, herein described is a method for protecting against faults in electrical equipment coupled to a power supply, the method comprising: measuring the load characteristics of a load connected to the power supply; determining if the load characteristics of the load connected to the power supply substantially match one or more load characteristics previously stored in a memory; interrupting the supply of power from the power supply in response based on determination of whether the load characteristics of the load connected to the power supply substantially match one or more load characteristics previously stored in the memory.

The method may include the feature where the load characteristics correspond to a representation of the current drawn by a load over time. The supply of power from the power supply is interrupted if the load characteristics of the load connected to the power supply do match one or more of the load characteristics stored in the memory.

In another embodiment, the present invention relates to a method for protecting against faults in electrical equipment coupled to a power supply, the method comprising: creating a library of load characteristics of electrical loads that may be connected to the power supply; measuring the load characteristics of an electrical load connected to the power supply; determining if the measured load characteristics substantially match one or more of the load characteristics in the library of load characteristics; and selectively interrupting the supply of power from the power supply in response to the determination of whether the measured load characteristics substantially match one or more of the load characteristics in the library of load characteristics.

In one embodiment, the step of creating a library of load characteristics comprises: performing the steps of measuring the load characteristics of an electrical load connected to the power supply, and determining if the measured load characteristics substantially match one or more of the load characteristics in the library of load characteristics; and adding the measured load characteristics to the library of load characteristics if the measured load characteristics do not match one or more of the load characteristics in the library of load characteristics.

In other embodiments, the devices and software may be adapted for more complex uses and devices. For example, an end-of-life indicator may be developed. Such device relates to there being typical failure modes in many pieces of equipment, particularly with things like motors, which may begin to draw more current or overheat as they age and the coils or bearings begin to fail. If those particular failure modes are repeatable, they can be programmed into the stored waveform library, and the device is set to trigger an alarm or indicator if there is a match to one of the particular stored waveforms. Another method is to pre-program the device with the normal operating conditions, like for an air conditioner, and then monitor for any variation and set off an alarm if anything changes, allowing one to seek service or to avoid catastrophic or potentially dangerous failure.

New circuit breakers can include arc-fault interrupter devices or GFCIs, if the circuit were to be dedicated to a particular use, such as a furnace, or a piece of industrial equipment. Accordingly, in one embodiment, the device of the present invention may be integrated into the breaker so that if an electrician or operator were working with or maintaining the equipment it could detect accidental contact to prevent electrocution, and all safeties (overload, arc-fault, GFCI and now two conductor contact) would be present in a single protection device. The device of the present invention may be like a GFCI receptacle, with one of more buttons accessible to a user. When a load is plugged in, like a lamp, the user would push the learn button, and turn the load on and off, and operate it, to allow learning to complete, after which it would provide protection. This would allow something else to be plugged in, but the learning would be redone each time. It could also be a “plug-in/screw-in” type of device for child-safety to retrofit existing receptacles or installations (that would be the separate device). It could also be integrated in a specific device (especially for the end-of life or danger indicators from the factory), much like new extension cords and air conditioners come with an arc fault protection device integrated into them to prevent fire in case of cord damage. The device of the present invention could be added to warn of device failure, not just cord failure.

In other embodiments, the present invention can be utilized as monitoring life-support outlets in hospitals to ensure that unauthorized devices are not connected (or disconnected) without approval. The invention may also be implemented in power utilities to help monitor for theft of electricity. The potential applications are broad, because of the learning nature of the invention.

While one embodiment is described in the flow chart of FIG. 6, certain aspects may be modified and still work, such as how many cycles must be in error before an error is detected. That step is to prevent false-positives from transient characteristics during turn-on or turn-off of a known device. An important aspect of the present invention is that there is a learning mode which stores distinct waveforms and then a normal or monitoring mode where every power cycle waveform is compared to the known waveforms. What happens after a fault is detected can be changed based on the actual device created, whether setting an alarm, turning off the circuit, or something else.

Current Flow Through the Human Body

The human body is not a simple resistive load, and varies from person to person due to a variety of parameters including age, gender, and moisture on the skin. Measuring the resistance between the two hands of a person using a battery powered multimeter would typically read between 250 kΩ and 2 MΩ. Measuring the resistance between the same two hands with a power source of a potential of 125V yields a value between 900Ω and 2675Ω. Table 1 below shows the difference in resistances between the two hands for different portions of the population at different voltages. P. S. Hamer, “The Three-Phase Ground-Fault Circuit-Interrupter System—A Novel Approach to Prevent Electrocution,” Industry Applications, IEEE Transactions, vol. 46, pp. 2276-2288, 2010. As the resistance varies due to a variety of parameters, the ranges found are shown by percentile. Table 1, below, shows typical impedances as measured hand to hand.

TABLE 1
Typical impedances as measured hand to hand.

| | Values for the total body impedances Z_{T}(Ω) | | |
|---|---|---|---|
| | that are not exceeded for: | | |
| Touch Voltage | 5% of the | 50% of the | 95% of the |
| (V) | population | population | population |
| 25 | 1,750 | 3,250 | 6,100 |
| 50 | 1,375 | 2,500 | 4,600 |
| 75 | 1,125 | 2,000 | 3,600 |
| 100 | 990 | 1,725 | 3,125 |
| 125 | 900 | 1,550 | 2,675 |
| 150 | 850 | 1,400 | 2,350 |
| 175 | 825 | 1,325 | 2,175 |
| 200 | 800 | 1,275 | 2,050 |
| 225 | 775 | 1,225 | 1,900 |
| 400 | 700 | 950 | 1,275 |
| 500 | 625 | 850 | 1,150 |
| 700 | 575 | 775 | 1,050 |
| 1,000 | 575 | 775 | 1,050 |
| Asymptotitc value = | 575 | 775 | 1,050 |
| internal impedance | | | |

Using the 125 V impedance levels in Table 1, as they are closest to the 120 V levels found in the United States, the range of current flow through a person encountering a 120 V connection hand to hand would range from 44 mA to 133 mA, calculated as follows:

$$\frac{120 V}{2675 Ω} = 44 mA$$

$$\frac{120 V}{900 Ω} = 133 mA$$

At current levels of 22 mA, over 99% percent of the population would not be able to “let go” of the circuit, meaning no person would be able to let go of the circuit conductors at 44 mA. In circumstances where moisture or a conductor has punctured the skin, the current flow through a person can be above these levels.

The current flow for the single line fault through a person is frequently below the “let go” threshold for many people and therefore has a lower probability to cause injury or death to the person (FIG. 7). As the total current flow for a two circuit conductor is likely to be greater than the “let go” threshold, a person encountering is more likely to seriously injured or killed.

If a person were to come in contact with a single line conductor in a circuit, the amount current that can flow through the person can vary depending on the resistance of the return path. In the circumstances where a person comes in contact with a single line conductor and the partially insulating materials, such as shoes and the floor, serve as a series resistor equivalent to 10 kΩ, the current flowing through the person would be only on the order of 10 mA (FIG. 8). In other circumstances where there is no return path, a person can be contact with a potential of 120 V or higher, feel nothing, and suffer no injury.

Establishing a Current Flow Threshold and Response Time

When a person is connected to an electrical circuit, the cause of injury or death is the current flow through the body by either inflicting burn damage or sending the heart into fibrillation. Current flow of less than 6 mA poses almost no risk for over 99% of the population. The danger posed to an individual is based on three different variables: (1) Current flow; (2) Time (length) of current flow; and (3) General health, and medical factors of the person exposed.

The higher the current flow, the longer the exposure, the more likely serious injury or death will occur. Research has already been done to establish a threshold for the maximum allowable current that can pass through a person before they will suffer any injury. This led to existing safety standards that state that the threshold is in the 6 mA to 30 mA depending on the safety standard. The required average response performance for GFCIs. At 20 mA, the response time is as long as a 1 second, while at 100 mA the response time is 100 ms. (FIG. 9).

While meeting previously established response times would be an ideal solution, having a unit act fast enough to prevent a human heart from going into fibrillation will significantly reduce the chance of permanent injury or death from shock. Lee established a formula determining the minimum time it would take a human heart to go into fibrillation based on experiments with calves of equivalent body mass to a human (FIG. 10). C. F. Dalziel and W. R. Lee, “Lethal electric currents,” IEEE Spectrum, vol. 6, no. 2, pp. 44-50, 1969.

$$\frac{K}{\sqrt{T}} = I$$

Where I is the current in mA, T is time in seconds, and K is a constant derived through experimentation with a minimum value of 116.

At a response time of 0.1 second, the device could prevent a person's heart from going into fibrillation, and would be under UL 943 defined response time for any fault less than 100 mA. Assuming 10 ms for the relay to actuate, it leaves 90 ms to determine the presence of a person in the circuit for the system (FIG. 11). Omron, “Power PCB Relay G4A;” http://www.components.omron.com/components/web/pdflib.nsf/0/89FA58314CB766F78525720 1007DD68E/$file/G4A_{—}0609.pdf (Accessed Dec. 9, 2011).

Human Analogue Load Choice

To experimentally test a device that will determine the presence of a body in the circuit, it is necessary to identify the best experimental model without using a live subject. Therefore, various meats that could be purchased at a grocery store or butchers were tested. It is important that the specific meat that is used for testing the device has characteristics similar to the human body. The specific resistance of lung, skeletal, or muscular tissue are in the 800-1000Ω per cm range. Fat has a somewhat higher resistance in the 1500 to 5 kΩ range. H. P. Schwan and C. F. Kay, “Specific Resistance of Body Tissues,” Circulation Research, vol. 4, no. 6, pp. 664-670, 1956. Blood has a lower resistance than tissue, approximately 150Ω per cm at the temperature of the human body (37° C.). Presence of blood will reduce the resistance and the warmer the blood, the lower its resistance (FIG. 12). T. S. Chilbert, T. E. Myklebus and et. al., “Fibrillation Induced at Powerline Current Level,” IEEE Transactions on Biomedical Engineering, vol. 36, no. 8, 1989.

The type of meat should have similar impedance values. In the process of choosing the best meat as the analogous load to be used for determining the unique electrical characteristics, several meats were tested with varying results. Chicken, pork and beef were purchased at grocery stores, and let to sit at room temperature (20° C.±3°) for at least 30 minutes before testing. The resistance of chicken rapidly climbed within seconds to the point of ceasing to draw enough current to be measured. A chicken thigh would draw between 10-15 mA when first connected, but would become drastically more resistive over time, eventually drawing less than 5 mA (FIG. 13). Pork had similar results to chicken and therefore was an unsuitable model. Beef proved to be the most practical load when testing. The current through beef ranged from 15 mA to 350 mA rms when connected to 120 V. The presence of blood in the pieces of beef may likely be why the resistance is similar to what would be expected of current flow through a person.

Beef Load Characteristics

The beef loads were almost entirely resistive at 60 Hz and can vary significantly depending on the fat content of the meat and distance across the probes are connected, and how the beef is connected to the loads. For example, a load may be connected via an embedded neutral probe (or “lead”) and an embedded line probe, or the load may be connected via an embedded neutral probe and a line probe being dragged across the surface (FIG. 14). When connecting the beef to a 120V source with wire leads directly inserted into the beef, the beef is a resistive load with a power factor typically at above 0.97 (FIG. 15). When embedding one lead embedded and the second lead dragged across the surface of the beef the current draw was lower and the power factor changed rapidly (FIG. 16).

Initial Load Testing

A test setup was built to allow the quick connection and disconnection of loads (FIG. 17). The human analogue, the beef, is connected via wire, while a NEMA 5-15 receptacle is used to connect electrical loads. Three loads were selected to test with the beef. They were selected based on their availability and representation of real world loads: (i) 60 W Incandescent Light Bulb; (ii) 12 W Compact Florescent Light Bulb (CFL); (iii) 5 W LED Light Bulb.

Each load was tested with and without the beef in parallel. The current waveforms gathered are divided into individual cycles based on the voltage signal (FIG. 18). Several techniques were used to detect any unique load characteristic in any of the bulbs compared to the current waveform of the load and the beef in both the frequency domain and the time domain. The results of the tests performed indicated differences in the waveform in the time domain were visible, but not unique enough to allow the beef compared to the light bulb to be identified conclusively (FIG. 19).

Known Load Only Approach

Instead of looking to detect the person in the circuit, a different approach was taken where any unknown load or current waveform would have the device turn off power. In one embodiment, the device has two operational states: “Learning Mode” and “Normal Mode.”

In Learning Mode, the device of the present invention will compare incoming waveforms to the stored library of waveforms. If the incoming waveform does not match an existing waveform within a degree of tolerance, the waveform is stored for future comparison (FIG. 20).

In Normal Mode, the device will compare incoming waveforms to stored waveforms that were stored during Learning Mode. If the incoming signal does not match a stored signal within a degree of tolerance, the device will disconnect power (FIG. 21).

This scheme relies on the loads attached to either be static, or have a recurring pattern such as an air conditioner compressor which will only be drawing significant current on infrequent and recurring cycles. This scheme protects a person from a fault in the same way that a GFCI protects a user from a ground fault. The GFCI does not differentiate whether the leakage current is flowing through a person or through a piece of equipment. This device does not differentiate between a person or any other unknown load in similar manner.

Mathematically Determining if a Signal is Unknown

Through trial and error, the technique to determine whether a signal is known or unknown is a combination of the summation of the mean square error (MSE) comparison, and the Pearson Correlation Coefficient. As noted above, however, other comparative analysis methods, or any combination thereof, may be used to determine whether a signal is known or unknown.

$$\begin{matrix}Mean Square Error = \frac{{\sum }_{i = 1}^{N} {[ {X ( i )}_{new} - {Y ( i )}_{stored} ]}^{2}}{N} & Equation 1 \\ \begin{matrix}Pearson Corr Coeff = \frac{{\sum }_{i = 1}^{N} {Z ( i )}_{new} * {Z ( i )}_{stored}}{N} ; where Z \\ = X - \frac{{\sum }_{i = 1}^{N} X ( i )}{σ ( X )}\end{matrix} & Equation 2\end{matrix}$$

The closer to zero the MSE is, and the closer to 1 the correlation coefficient is, the closer the waveform being analyzed is to a known waveform. If the MSE is less than an experimentally determined value (M) and the correlation coefficient is greater than an experimentally determined value (N), the signal is similar enough to the known signal to be considered “known” (FIG. 22).

Automated Testing to Determine MSE and Correlation Coefficient

As the device can store multiple signals, the new waveform will need to have the MSE and correlation coefficient calculated against each of the stored or learned waveforms (FIG. 23). If the new waveform matches any of the stored waveforms, it is considered a known signal.

The automated testing program was created in LabVIEW with a 3000 series Picoscope for data acquisition. The LabVIEW program was created based on a provided oscilloscope virtual instrument. Each saved waveform is stored as a row in a two dimensional array with each waveform consisting of approximately 800 samples. FIG. 24 illustrates the saved waveforms of an incandescent light bulb and a compact florescent light bulb (CFL) on at different times.

Compensating for Voltage Drift

The nominal line to neutral voltage in the US is 120 V with an acceptable drift between 110 V to 126 V. National Electrical Manufacturer's Association, American National Standard for Electric Power Systems and Equipment—Voltage Ratings (60 Hertz), National Electrical Manufacturer's Association (NEMA), 2006. The magnitude of the current waveform will shift for certain loads as the voltage changes. When testing several conventional loads, the waveform shape will stay nearly identical and not related to the voltage drift except for the magnitude. To compensate for the voltage drift, all waveforms are normalized between −1 and 1 for analysis.

No Load Conditions

It was necessary to test what would occur if no loads were connected to the device to determine whether the device should be turned on before connecting it to a circuit or only when the circuit was established. Any noise induced or radiated into the system will be scaled when normalized, and would appear as an unknown waveform. In Learning Mode, it would cause the number of learned waveforms to rise rapidly while providing no value. In Normal Mode, it would cause a false positive for a possible person being connected. To resolve this issue, a current flow check is performed before any incoming waveforms are evaluated. If 20 mA rms of current is flowing through the circuit, the device will evaluate the waveform. If less than 20 mA of current is flowing, the device will ignore the waveform. (FIG. 25).

High Frequency Noise

Certain loads such as those with switching power supplies or ballasts can create current waveforms with high frequency components. To compensate for high frequency noise, a third order Butterworth low pass filter with a frequency of approximately 3 kHz is applied to all waveforms (FIG. 26). The frequency response of living tissue can drop by 20 percent in the range of 10 Hz to 1 kHz leaving the overall frequency response of interest in the lower frequency range.

On/Off Transitions

The exact time the load turns on in the ac cycle can significantly affect the current waveform. The same load turned on at different times during a single 60 Hz cycle produces different waveforms. The device would have to learn the behavior of loads connecting turning on in many different portions during the ac cycle, and the settings the load is set to when it is turned on (FIG. 27).

To resolve the “turn on” issue, a significant change to the detection structure was needed. The method of comparison of signals was kept the same, although now the device would take two unknown waveforms in a row before either storing a waveform in Learning Mode or disconnecting power in Normal Mode. This allowed sufficient settling time for the waveform to reach its new steady state after a load is switched on or off. Note, in FIG. 28, the program flow has changed where the Learning and Normal Mode portions are included in the same overall flow program section.

In one embodiment, the present invention uses LabVIEW as the programming platform (FIG. 29). The invention may take alternate forms and the sensitivity ranges (MSE, Correlation Coefficient comparison values, and low pass filter values) may be adjusted depending on the hardware employed. For example, similar microcontrollers or platforms designed to do real time digital signal processing are suitable, as many of these devices can carry out multiple calculations on signals in parallel.

Testing with Animal Tissue

In one embodiment, the resistive load issue may turn out to not require an auto-ranging mode when testing with animal skin contact as it may produce results similar to when the leads were dragged across the surface of the human analog.

Integration Circuit Breakers

Circuit breakers are devices that automatically disconnect power to a circuit when the current flow is at or above a predetermined value for a predetermined time. In one embodiment, the automatic disconnect threshold of a circuit breaker is normally several orders of magnitude higher than the current waveforms required disconnect power with the device of the present invention. The primary function of a circuit breaker is to protect the wire used in a circuit from overheating and causing a fire. Combination Circuit Breaker/GFCI or Circuit Breaker/AFCIs are commercially available. Schneider Electric, “QO120 Product Detail,” http://products.schneider-electric.us/products-services/product-detail/?event=productDetail&countryCode=us&partNumber=QO120GFI (Accessed Dec. 9, 2011); Schneider Electric, “Combination Arc-Fault Circuit Interrupters,” http://products.schneider-electric.us/products-services/products/circuit-breakers/miniature-circuit-breakers/combination-arcfault-circuit-interrupters/ (Accessed Dec. 9, 2011). In one embodiment, placing the device at the circuit breaker would make sense for certain types of loads such as florescent lighting loads hard wired into a building. Integration into a circuit breaker means the same disconnection means used to open the circuit in an overcurrent situation can be used to open the circuit when the presence of human in the circuit is detected.

Integration with Receptacles

Integration with a receptacle is a common practice for wiring device manufacturers. Leviton Manufacturing Co., “X7599>Tamper Resistant Duplex,” http://www.leviton.com/OA_HTML/ibeCCtpItmDspRte.jsp?item=680335& section=33614&min isite=10026 (Accessed Dec. 18, 2011); Hubbell Wiring Device, “Hubbell GFCI Receptacles,” http://www.hubbell-wiring.com/press/pdfs/H5212.pdf (Accessed Dec. 18, 2011). In one embodiment, placing the device at the receptacle with controls similar to those found on GFCIs would provide a user-recognizable interface. Having the point of deployment close to the point of connection allows quicker access to the controls when needed. See, e.g., FIG. 32.

Integration with Utilization Equipment

A manufacturer of utilization equipment such a motor, air conditioner, or vending machine could integrate a version of the device of the present invention into their equipment. The manufacturer could pre-load all the known waveforms the device is likely to encounter during operation and the device could have a limited Learning Mode to deal with slightly different performance from unit to unit.

Appropriate Place in the Electrical Codes and Standards

Any safety device for personnel protection would need to be considered as such needs to be codified as a safety device by UL or another Nationally Recognized Testing Laboratory. The National Electrical Code works on three year cycles. In general, for a type of equipment to be considered for large scale install, or use as standard process it needs to be defined and specified. Standard practice is to introduce the definition of a new device in one set of revisions, with locations where the device may be used, and then require use in the next set of National Electrical Code revisions. Timeline for new device requirements are likely to take six years or longer.

Another embodiment is one that can monitor the current waveforms and disallow unauthorized loads from being connected. It could either not provide power to the unauthorized load or remotely alert the appropriate personnel that an unauthorized load has been connected.

An additional variation of the inventive device is for a manufacturer to load it with waveforms that their equipment only produces when it is failing. This variation of the device would alert the user or disconnect power to the equipment only when the equipment is exhibiting behavior that appears to be an internal fault.

### Example

The equipment employed in this example included:
Power source capable of providing at least 12 A at 120 V 60 Hz
Variac or adjustable transformer capable of adjustment between 120V-110V
RCD, switch, or other device to allow safe connection to power leads
Shunt Resistor, 0.5Ω, rated for at least 25 W
Switch for disconnecting the human analogue substance from the circuit
Wire connection for human analogue substance
Human analogue substance (e.g., beef) for load testing
Output receptacle for connecting most loads

The equipment was assembled as shown in FIG. 5.

A test set up was built (FIGS. 6 and 30) using an autotransformer (T1) to simulate possible voltage droops, a Residual Current Device (RCD1) to provide a degree of protection for the operator when connecting loads, a shunt resistor R1 for current measurement, a NEMA 5-15 receptacle to connect other loads, and a switch (S1) to connect and disconnect power to the human analogue substance (in this case, a piece of beef). The Residual Current Device operates on the same principle as the GFCI and did not trip during testing. A digital oscilloscope was used to measure the voltage, as well as the current by measuring the voltage drop across R1. The data from the oscilloscope was then processed by a computer running LabVIEW which serves as the signal processing device (SPD).

Single Load Testing Methodology

The following method was used to test the operation and the effectiveness of the set up using a single load:

1. Let human analogue substance sit at room temperature (20° C.±3°) for 30 minutes

2. Set device to “Learning Mode”

3. Connect load

4. Turn electrical load on, adjust any settings on the load, wait 5 minutes

5. Adjust voltage between 120V and 110V

6. Turn on and off electrical load with voltage set 120V 4× times

7. Turn on and off electrical load with voltage set to 110V 4× times

8. Record number of waveforms saved

9. Set to Normal Mode

10. Turn on and off electrical load with voltage set 120V 4× times

11. Turn on and off electrical load with voltage set to 110V 4× times

12. Record if fault occurs, any fault is a failure

13. Turn on human analogue substance

14. Record if fault occurs, lack of a fault is a failure

Two Load Testing Methodology

The following method was used to test the operation and the effectiveness of the set up using two loads:

1. Let human analogue substance sit at room temperature (20° C.±3°) for 30 minutes

2. Set device to Learning Mode

3. Connect both electrical loads

4. Turn electrical load 1 on, adjust any settings on the load, wait 5 minutes

5. Adjust voltage between 120V and 110V

6. Turn on and off electrical load 1 with voltage set 120V 4× times

7. Turn on and off electrical load 1 with voltage set to 110V 4× times

8. Leave electrical load 1 on for 5 minutes, interact or adjust settings on load if possible

9. Turn electrical load 2 on, adjust any settings on the load, wait 5 minutes

10. Adjust voltage between 120V and 110V

11. Turn on and off electrical load 2 with voltage set 120V 4× times

12. Turn on and off electrical load 2 with voltage set to 110V 4× times

13. Set to normal mode

14. Turn on and off electrical loads 1 and 2 with voltage set 120V 4× times

15. Record number of waveforms saved

16. Record if a fault occurs, any fault is a failure

17. Turn on human analogue substance

18. Record if a fault occurs, lack of a fault is a failure

Signal Analysis Algorithm

The incoming current signal is first divided into individual waveforms of approximately 800 samples. The rms current value of each waveform is determined. If the rms current value is below a particular threshold, such as 20 mA, the signal is ignored as there is likely to be little risk to a person at this current threshold as the expected minimum current flow through a person at 120 V is 33 mA. The 20 mA threshold is also an accepted safety threshold in the US and Canada for personnel protection on certain circuits. This threshold prevents false positives from system noise when no load is connected and the waveform is normalized, as described in later steps.

The waveform is then run through a third order low pass filter with a corner frequency of 3 kHz. It is then normalized to values between −1 and 1. The waveform is compared against any known signals stored in the signal processing device (SPD). A combination of the mean square error (Equation 1) and Pearson correlation coefficient (Equation 2) is used for signal comparison.

$$\begin{matrix}Mean Square Error = \frac{{\sum }_{i = 1}^{N} {[ {X ( i )}_{new} - {Y ( i )}_{stored} ]}^{2}}{N} & Equation 1 \\ \begin{matrix}Pearson Corr Coeff = \frac{{\sum }_{i = 1}^{N} {Z ( i )}_{new} * {Z ( i )}_{stored}}{N} ; where Z \\ = X - \frac{{\sum }_{i = 1}^{N} X ( i )}{σ ( X )}\end{matrix} & Equation 2\end{matrix}$$

If a new waveform has both a mean square error above a predefined threshold (M) and a Pearson correlation coefficient below a predefined threshold (N) the waveform is considered unknown and an internal counter is incremented. If the signal is known the internal counter is reset to 0. If the internal counter reaches 2 and the ULID is in Learning Mode, the new waveform is stored. If the ULID is in Normal mode when the counter reaches 2 the SPD will signal that an unknown load has been detected. The overall algorithm is shown in FIG. 6.

The values of M and N were raised and lowered in various tests to find a point at which the presence of the human analogue triggered the SPD. Common loads such as incandescent, compact florescent and LED lights, and loads with switching power supplies were connected to the test circuit. The loads were energized, actuated, and otherwise operated for 5 minutes in Learning Mode. The ULID is then switched to Normal Mode, where the load remains connected while the beef is connected to the circuit in parallel with the load. Several different loads were tested and a variety of cases needed to be dealt with to prevent false detection of an unknown load when none were present (reducing occurrence of false positives). FIG. 30 illustrates the stored signals acquired during Learning Mode of an incandescent bulb and CFL, they are placed on the same graph demonstrate the different types of waveforms stored in the library.

The determination of MSE and the Correlation Coefficient comparison values (M, and N respectively) was set to meet two specific criteria: (1) detect unknown loads connected to a circuit as often as possible; and (2) have as few false fault detections as possible.

To do this a variety of different values for MSE and Correlation comparison values were tested as well as an alternate signal comparison VI set to “Equal Within Tolerance” in Labview® 2011. A test plan was written using load types likely to be found in the home, office, and industrial environments.

All testing was done with an indicator inside of a LabVIEW® Virtual Instrument (VI) acting as a stand in for disconnecting power. In addition, the total number of waveforms saved, and the total number of faults recorded since the VI was first started is displayed.

Tests were done with one load at a time in parallel with the beef (Table 2), followed by two loads in parallel with the beef (Table 3).

The wire leads were embedded in the beef, and the beef was energized via a switch. The device was able to correctly detect the presence of the human analog load when in parallel with loads that are not resistive with 0.985 set for the correlation coefficient comparison, and 0.015 for mean square error comparison values. These values can vary (+/−0.005) with very little difference in performance.

TABLE 2
Single Load Test, Leads Embedded in Beef (current
resolution major division 100 mA (200 mV))
SPD Unknown Load Detection with a single load
Corr. Coeff. Set to 0.985 (N) and MSE set to 0.015 (M)

| | Waveforms | Fault Detected | Fault Detected |
|---|---|---|---|
| Load | Learned | w/o beef | w. beef |
| Light Bulb (60 W) | 1 | No | No |
| CFL (12 W) | 7 | No | Yes |
| LED Bulb (7 W) | 114 | No | Yes |
| Laptop | 23 | No | Yes |
| Television | 6 | No | Yes |
| Wii | 3 | No | Yes |
| Audio Receiver | 3 | No | Yes |

TABLE 3
Two Load Tests with Leads Embedded in Beef
SPD Unknown Load Detection with Two Loads
Corr. Coeff. Set to 0.985 (N) and MSE set to 0.015 (M)

| | Load | | | | |
|---|---|---|---|---|---|
| | | | | | Audio |
| Load | CFL | LED Bulb | TV | Wii | Receiver |
| Bulb | 3/no/* | 21/no/* | 7/no/* | 4/no/* | 3/no/* |
| CFL | | 11/no/yes | 11/no/yes | 5/no/yes | 19/no/yes |
| LED | | | 6/no/yes | 4/no/yes | 8/no/yes |
| TV | | | | 7/no/yes | 7/no/yes |
| Wii | | | | | 10/no/yes |

*SPD unable to detect beef when only incandescent bulb is turned on.

The inability to detect the presence of the human analogue when in parallel with a resistive load like an incandescent light bulb was a concern. Additional testing was done with an incandescent load alone to see if more sensitive settings would enable the device to detect the presence of the human analogue. With the sensitivity of the device raised repeatedly (Table 3) there were no settings that allowed the device to correctly detect the presence of the human analogue when the leads were embedded in the beef. When one of the leads was dragged across the beef, the device was able to intermittently detect the presence of a person with an MSE comparison value (M) of 0.115 and Correlation Coefficient value (N) of 0.985. When the sensitivity was raised to an M value of 0.001 and N value of 0.9993, the device was able to detect the presence of the human analogue on first connection approximately one out of every 5 times (Table 4).

TABLE 4
MSE and Corr Coef Values tested with incandescent
bulb, 1 lead dragged across

| | Corr | Waveforms | False Detection | Detection w/Beef, |
|---|---|---|---|---|
| MSE | Coeff | Stored | w/o Beef | 1 lead dragged |
| 0.11500 | 0.985 | 1 | No | Intermittent, infrequent |
| 0.01000 | 0.9850 | 1 | No | Intermittent, infrequent |
| 0.00250 | 0.9950 | 1 | No | Intermittent, infrequent |
| 0.00250 | 0.9993 | 1 | No | Intermittent, infrequent |
| 0.00200 | 0.9993 | 1 | No | Intermittent, infrequent |
| 0.00100 | 0.9993 | 1 | No | Intermittent, 1 out 5 |
| | | | | times approx. |
| 0.00100 | 0.9995 | 2 | No | Intermittent, 1 out 5 |
| | | | | times approx. |
| 0.00030 | 0.9995 | 4 | No | Intermittent, 1 out 5 |
| | | | | times approx. |
| 0.00030 | 0.9997 | 21 | No | Intermittent, 1 out 3 |
| | | | | times approx. |
| 0.00030 | 0.9998 | 500 Plus | Yes | N/A |
| 0.00025 | 0.9997 | 500 Plus | Yes | N/A |

To properly detect the human analogue, the low pass filter threshold was raised to 12 kHz along with increasing the sensitivity settings (Tables 5 and 6). With these settings, the device was able to detect the presence of the human analogue when the wire leads are dragged or placed on surface of the beef, and intermittently detect the beef when the wire leads are embedded in the beef. When connecting non-resistive loads, at the settings that allowed detection of a human analog with a resistive load, more than 1000 waveforms were saved by the Device within two minutes.

TABLE 5
Load Testing with Low Pass Filter adjustments

| | | | | | Detection | Detection |
|---|---|---|---|---|---|---|
| | | Wave- | | False | w/Beef, | w. Beef, |
| | Corr | forms | Low Pass | Detection | 1 lead | both leads |
| MSE | Coeff | Stored | Settings | w/o Beef | dragged | embedded |
| 0.003 | 0.998 | 1 | 9 kHz, | No | Inter- | No |
| | | | 1st Order | | mittent | |
| 0.003 | 0.998 | 1 | 12 kHz, | No | Yes | Inter- |
| | | | 1st Order | | | mittent |
| 0.002 | 0.998 | 1 | 12 kHz, | No | Yes | Inter- |
| | | | 1st Order | | | mittent |
| 0.0015 | 0.998 | 2 | 12 kHz, | No | Yes | Inter- |
| | | | 1st Order | | | mittent |

TABLE 6
Non resistive loads tested at values for resistive loads
Corr. Coeff. Set to 0.998 and MSE set to 0.003,
low pass filter set to 12 kHz 1^{st} order

| | | Fault | Fault | Current |
|---|---|---|---|---|
| | Waveforms | Detected | Detected | resolution |
| Load | Learned | w/o Beef | w/Beef | Major division |
| Light Bulb | 1 | No | Yes | 100 mA (200 mV) |
| (60 W) | | | | |
| CFL (12 W) | 1000+ | Not | Not | 100 mA (200 mV) |
| | | performed | performed | |
| LED Bulb | 1000+ | Not | Not | 100 mA (200 mV) |
| (7 W) | | performed | performed | |
| Laptop | 1000+ | Not | Not | 100 mA (200 mV) |
| | | performed | performed | |

*When 1 lead is first inserted or dragged across the surface

Testing With Larger Loads

The digital to analog conversion device used for data acquisition by the PicoScope 3000 series has 8 bits of resolution. “Pico Technology,” http://www.picotech.com/document/datasheets/PicoScope3000.pdf (Accessed Dec. 17, 2011). The measurement range has to be set depending on what loads are connected. When testing with an air conditioner with a nominal power draw of 400 W when at full draw, the resolution of the PicoScope was set to 500 mA per major division. With this larger scale, the device was still able to detect the presence of the human analogue although the MSE, and Correlation Coefficient values had to change due to the change in resolution (Table 7).

TABLE 7
Single Load Test with resolution set to 1 V per major division

| | | Fault | Fault | | | |
|---|---|---|---|---|---|---|
| | Waveforms | Detected | Detected | Corr. | | Current resolution |
| Load | Learned | w/o Beef | w/ Beef | Coeff. | MSE | Major division |
| Air | 10 | No | Yes | 0.995 | 0.0025 | 500 mA (1 V) |
| Conditioner | | | | | | |
| CFL (12 W) | 69 | No | Yes | 0.995 | 0.0025 | 500 mA (1 V) |
| LED Bulb (7 W) | 425 | No | Yes | 0.995 | 0.0025 | 500 mA (1 V) |
| Laptop | 38 | No | Yes | 0.995 | 0.0025 | 500 mA (1 V) |
| Television | 95 | No | Yes | 0.995 | 0.0025 | 500 mA (1 V) |
| Wii | 25 | No | Yes | 0.995 | 0.0025 | 500 mA (1 V) |
| Audio | 8 | No | Yes | 0.995 | 0.0025 | 500 mA (1 V) |
| Receiver | | | | | | |
| Light Bulb | 1 | No | Yes | 0.995 | 0.0025 | 500 mA (1 V) |

*When low pass filter is set to 12 kHz 1^{st} order, 1 lead dragged or placed on top.

Testing on the Secondary of an Isolation Transformer

The device of one embodiment of the invention was able to detect faults when both the load and human analogue were connected to the secondary of a 1:1 isolation transformer (Table 8). The testing was letting the load settle for 2 minutes before connecting the human analogue and verifying it caused a fault immediately.

TABLE 8
Simplified Test with a 1:1 Isolation transformer

| | Waveforms | Fault Detected | Current resolution |
|---|---|---|---|
| Load | Learned | w. Beef | Major division |
| Light Bulb (60 W) | 1 | No | 100 mA (200 mV) |
| CFL (12 W) | 4 | Yes | 100 mA (200 mV) |
| Laptop | 12 | Yes | 100 mA (200 mV) |
| Television | 73 | Yes | 100 mA (200 mV) |

Summary of Test Results

The device of one embodiment of the invention was able to accurately detect the presence of the human analogue when in parallel with all non-resistive loads, and intermittently detect incidental contact of the human analogue under certain circumstances. A set of more sensitive parameters (Table 5) were used to detect the presence of the human analogue when in parallel with resistive loads only.

In one embodiment, the response time of the device is as quick as LabVIEW can perform the calculations, after 2 ac cycles have passed. Any real time implementation would have an ideal maximum response time of 43-45 ms: 33 ms for the 2 waveforms to elapse, 1-2 ms to finish the calculations, and 10 ms for the relay or solenoid in the circuit to disconnect power (FIG. 32). The response time is less than of the determined time of Section Error! Reference source not found. and is the same as the required GFCI response time for faults of 175 mA or less (FIG. 31).

High Frequency Signal Injection

To get around the lack of unique characteristics, high frequency signal injection was explored. There was a need to take into consideration the effect on other loads on the system. Any high frequency signal injection would have to be something that is not high enough to be filtered out by the inherent inductive characteristics of long runs of cable or motor loads attached to the system. After further exploration, the human or biological system showed a relatively small shift of 20% in the range of 10 Hz to 1 kHz. FIG. 35; H. P. Schwan and C. F. Kay, “Specific Resistance of Body Tissues,” Circulation Research, vol. 4, no. 6, pp. 664-670, 1956.

Electrical Characteristics of a heart in fibrillation

Fibrillation is an irregular, non rhythmic, heart beat. An extreme case would be looking at possible electrical characteristics of a heart in fibrillation. While a heart in fibrillation is an extreme case, and represents a situation where a person will need medical attention immediately, disconnecting a circuit when heart fibrillation is detected would prevent further damage. No sufficient data was found to back up any unique electrical signals, so due to the risks involved it was not explored.

Response Change Over Time

The human body may not normally be easily detectable when first connected, but there may be shifts relative to time. Testing for such a signal type may not be practical as it would require a living analog connected to a circuit that could be injured. No sufficient data was found to back up any unique electrical signals, so due to the risks involved.

Human Circuit Analogue

To develop a ULID, it was necessary to identify an appropriate means of testing without using a live subject. Using the impedance values determined in Hamer, supra, of 900Ω and 2625Ω for a 125 V potential, the expected current flow through a person connected to a 120 V source is between 44 mA and 133 mA.

To provide a close analogue to human conduction, beef proved to be the most practical load when testing. After allowing beef to sit at room temperature (20° C.±3°) for 30 minutes before testing, the current through the beef ranged from 15 mA to 350 mA rms when connected to a 120 V ac source. The presence of blood in the beef likely explains why the resistance is similar to what would be expected of current flow through a person.

Known Load Approach

As described above, an algorithm was developed where any unknown load(s) attached to the system would be sufficient cause to recognize as a fault. This mirrors the design of GFCIs where any current leakage to ground, irrespective of the cause will result in the GFCI disconnecting power. For signal comparison, the ac current measurements are divided by individual cycles based on the voltage signal to be used for analysis. Each cycle is treated as a separate waveform.

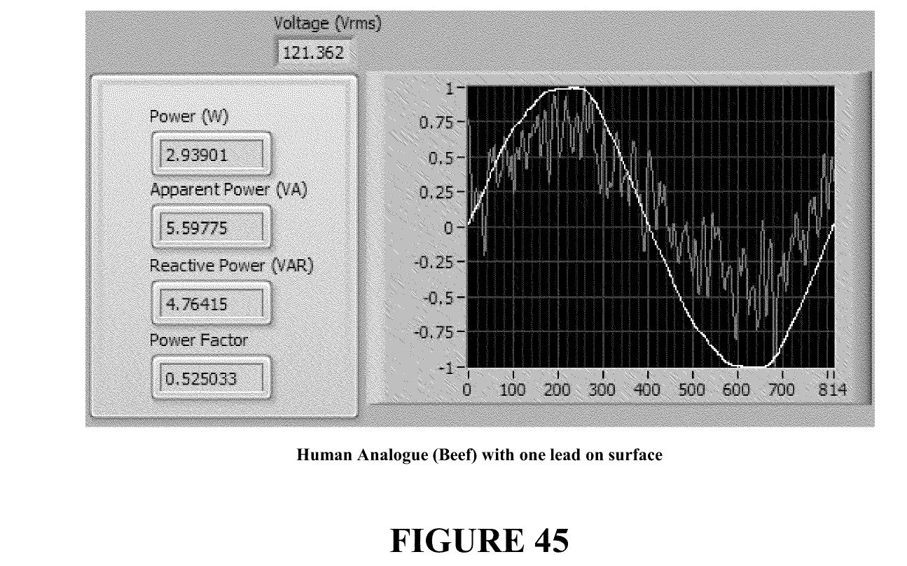

The ULID was able to effectively detect the fault with all of the below loads with the exception of the incandescent light bulb. Table 8 shows the number of waveforms stored during Learning mode, whether a false positive was detected without the presence of the beef, and whether a fault was accurately detected when the beef was present. An Incandescent Bulb, Compact Florescent Bulb (CFL), LED Bulb, HP Elitebook Laptop, Flat-screen Television and a Nintendo Wii were used as loads. (FIGS. 33-48). The threshold values for N and M were chosen to eliminate false positives while still ensuring detection. Resistive loads such as incandescent bulbs were too close in shape and phase to that of the beef. When identical loads are connected in parallel there is no change in the waveform shape and phase to detect. However, in some tests, momentary or brushing contact of the leads on the beef did allow detection, due to the transient response as contact is made. This observation points to the likelihood that applications in fault detection involving human contact would not be hindered by the presence of existing resistive loads on the network. There are also methods being explored which will allow a dynamic change of detection conditions and thresholds when a resistive load is connected, which will allow for ready detection of faults.

Further testing was performed with two known loads in parallel with the beef to demonstrate the versatility of the ULID (Table 3). Each individual entry records the number of waveforms learned/whether a false positive was detected/and whether the beef was accurately detected. During learning mode, both devices were cycled on and off in various combinations. The ULID was able to detect the presence of the beef when put in parallel with the incandescent bulb and any second load. If the second load was turned off, the beef was not detected. This demonstrates the ULID's ability to detect unknown loads on a circuit with multiples loads, although the learning process becomes exponentially more complicated with each additional load.

### CONCLUSION

The method of having a ULID detect unknown load(s) shows potential as a circuit monitoring and protection device. Once detection is done, the ULID can simply trigger an appropriate relay to shut-off the device for circuit protection, much as a GFCI does. Ultimately devices based on this type of technology could replace the function of GFCIs while providing protection from a larger class of faults. Large scale testing with different loads and user behaviors needs to be done to determine the ideal parameters, and location for deployment. There are other potential applications and points-of-use for protection devices based on this method. Known signals could be preloaded at manufacture to ULIDs without a specific Learning mode and attached to the supply cord of a piece of equipment. A point of use device could allow a user to select Learning mode when first connecting a piece of equipment. There could be specialty ULIDs attached to specific loads such as florescent lighting, LED lighting, or electronics. A manufacturer of a piece of electrical equipment could pre-load a ULID with the all the known waveforms of their equipment under normal operation, and the ULID could be used to alert the user of a failure in such equipment.

While the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

While the invention has been described in connection with certain embodiments, it is to be understood that the invention is not limited to such embodiments, but, on the contrary, is intended to cover various modifications and equivalent arrangements and components within the spirit and scope of the appended claims.

We claim:

1. An apparatus for protecting against faults in electrical loads connected to a power supply, the apparatus comprising:
a memory;
a signal processing device comprising logic for measuring the load characteristics of a load connected to the power supply, logic for determining if the load characteristics of the load connected to the power supply substantially match one or more load characteristics previously stored in the memory, and logic for selectively generating a control signal in response to whether the load characteristics of the electrical load substantially match the load characteristics stored in the memory; and
a switch coupled to the signal processing device for selectively interrupting the supply of power from the power supply in response to the control signal generated by the signal processing device.

2. The apparatus of claim 1 wherein the load characteristics correspond to a representation of the current drawn by a load over time.

3. The apparatus of claim 1, wherein the logic for selectively generating the control signal generates the control signal if the load characteristics of the load connected to the power supply do match one or more of the load characteristics stored in the memory.

4. The apparatus of claim 1, further comprising an input control for placing the apparatus in a learning mode or a protection mode.

5. The apparatus of claim 1 or 4, wherein the logic for selectively generating the control signal generates the control signal if the load characteristics of the load connected to the power supply do not match one or more of the load characteristics stored in the memory.

6. The apparatus of claim 4 wherein the signal processing device further comprises logic for causing the load characteristics of the load connected to the power supply to be stored in the memory if the apparatus is in the learning mode and if the load characteristics of the load connected to the power supply do not match one or more of the load characteristics stored in the memory.

7. The apparatus of claim 1 wherein the logic for determining if the load characteristics of a load connected to the power supply substantially match one or more load characteristics previously stored in the memory comprises logic for calculating the mean square error and the Pearson correlation coefficient.

8. The apparatus of claim 7 wherein the signal processing device determines that two load characteristics match if the mean square error is less than a first value, and if the Pearson correlation coefficient is greater than a second value.

9. An apparatus for protecting against faults in electrical equipment connected to a power supply, the apparatus comprising:
a memory;
means for measuring the load characteristics of an electrical load connected to the power supply;
comparison means for determining if the load characteristics of the electrical load substantially match the load characteristics stored in the memory;
means for generating a control signal based on the comparison of the load characteristics of the electrical load to the load characteristics stored in memory; and
means for interrupting the supply of power from the power supply in response to the control signal.

10. The apparatus of claim 9 wherein the load characteristics correspond to a representation of the current drawn by a load over time.

11. The apparatus of claim 9 wherein the means for selectively generating the control signal generates the control signal if the load characteristics of the load connected to the power supply do match one or more of the load characteristics stored in the memory.

12. The apparatus of claim 9 further comprising means for placing the apparatus in a learning mode and an operational mode.

13. The apparatus of claim 9 or 12 wherein the means for selectively generating the control signal generates the control signal if the load characteristics of the load connected to the power supply do not match one or more of the load characteristics stored in the memory.

14. The apparatus of claim 9 further comprising means for causing the load characteristics of the load connected to the power supply to be stored in the memory if the apparatus is in the learning mode and if the load characteristics of the load connected to the power supply do not match one or more of the load characteristics stored in the memory.

15. The apparatus of claim 9 further comprising means for calculating the mean square error and the Pearson correlation coefficient.

16. The apparatus of claim 15 wherein the comparison means determine that two load characteristics match if the mean square error is less than a first value, and if the Pearson correlation coefficient is greater than a second value.

17. A method for protecting against faults in electrical equipment coupled to a power supply, the method comprising:
measuring the load characteristics of a load connected to the power supply;
determining if the load characteristics of the load connected to the power supply substantially match one or more load characteristics previously stored in a memory;
interrupting the supply of power from the power supply in response based on determination of whether the load characteristics of the load connected to the power supply substantially match one or more load characteristics previously stored in the memory.

18. The method of claim 17 wherein the load characteristics correspond to a representation of the current drawn by a load over time.

19. The method of claim 17 wherein the supply of power from the power supply is interrupted if the load characteristics of the load connected to the power supply do match one or more of the load characteristics stored in the memory.

20. The method of claim 17 wherein the supply of power from the power supply is interrupted if the load characteristics of the load connected to the power supply do match one or more of the load characteristics stored in the memory.

21. The method of claim 17 further comprising causing the load characteristics of the load connected to the power supply to be stored in the memory if the load characteristics of the load connected to the power supply do not match one or more of the load characteristics stored in the memory.

22. The method of claim 17 wherein the step of determining if the load characteristics of the load connected to the power supply substantially match one or more load characteristics previously stored in a memory comprises calculating the mean square error and the Pearson correlation coefficient.

23. The method of claim 22 wherein the step of determining if the load characteristics substantially match comprises determining that two load characteristics match if the mean square error is less than a first value, and if the Pearson correlation coefficient is greater than a second value.

24. A method for protecting against faults in electrical equipment coupled to a power supply, the method comprising:
creating a library of load characteristics of electrical loads that may be connected to the power supply;
measuring the load characteristics of an electrical load connected to the power supply;
determining if the measured load characteristics substantially match one or more of the load characteristics in the library of load characteristics; and
selectively interrupting the supply of power from the power supply in response to the determination of whether the measured load characteristics substantially match one or more of the load characteristics in the library of load characteristics.

25. The method of claim 24 wherein the step of creating a library of load characteristics comprises:
performing the steps of measuring the load characteristics of an electrical load connected to the power supply, and determining if the measured load characteristics substantially match one or more of the load characteristics in the library of load characteristics; and
adding the measured load characteristics to the library of load characteristics if the measured load characteristics do not match one or more of the load characteristics in the library of load characteristics.
